(19) United States
(12) Patent Application Publication
(10) Pub. No.: US 2016/0078695 A1
(43) Pub. Date: Mar. 17, 2016

(54) METHOD AND SYSTEM FOR MANAGING A FLEET OF REMOTE ASSETS AND/OR ASCERTAINING A REPAIR FOR AN ASSET

(71) Applicant: General Electric Company, Schenectady, NY (US)

(72) Inventors: Shawn Arthur McClintic, Erie, PA (US); Nicholas E. Roddy, Clifton Park, NY (US); David Richard Gibson, North East, PA (US); Glenn Robert Shaffer, Erie, PA (US); Louis Andrew Schick, Delmar, NY (US); Michael James Pierro, Erie, PA (US); William Roy Schneider, Erie, PA (US); Kimberley M. Mangino, Niskayuna, NY (US); Gregory James Hampson, Saratoga Springs, NY (US); Paul Edward Cuddihy, Schenectady, NY (US); Gregory John Fera, Erie, PA (US); Richard Gerald Bliley, Erie, PA (US); Luis Ivan Meneses, Erie, PA (US); James E. Schlabach, Erie, PA (US)

(21) Appl. No.: 14/953,250

(22) Filed: Nov. 27, 2015

Related U.S. Application Data
(63) Continuation-in-part of application No. 14/032,429, filed on Sep. 20, 2013.
Application No. 14/032,429 is a continuation-in-part of application No. 10/199,717, filed on Jul. 18, 2002.

(51) Int. Cl. G07C 5/08

(52) U.S. Cl. CPC G07C 5/0816; G07C 5/0808; G07C 5/085

(57) ABSTRACT

Systems and methods described herein relate to indicating a repair to perform on an asset based on historic data related to a repair on the asset and/or sensor data associated with the asset. An evaluate component aggregates information related an asset such as a repair performed or data from a sensor. A repair evaluation component indicates a repair to perform on the asset based on at least one of the data from the sensor or the information related to the asset. By utilizing asset-specific information and historical data, repair schedules for assets can be more accurate and thereby reducing untimely repairs.

### CROSS-REFERENCE TO RELATED APPLICATIONS

This application is a continuation-in-part of U.S. patent application Ser. No. 14/032,429, filed 20 Sep. 2013 (the “'429 Application”), which claims the benefit of U.S. Provisional Application Ser. No. 61/704,691, filed 24 Sep. 2012 (the “'692 Application”). This application also is a continuation-in-part of U.S. patent application Ser. No. 10/199,717, filed 18 Jul. 2002 (the “'717 Application”), which is a continuation-in-part of U.S. patent application Ser. No. 09/736,495, filed 13 Dec. 2000 (the “'495 Application”) and issued as U.S. Pat. No. 7,783,507 on 24 Aug. 2010, which claims the benefit of U.S. Provisional Patent Application No. 60/201,243 filed 1 May 2000 (the “'243 Application”). The '495 Application also is a continuation-in-part of U.S. patent application Ser. No. 09/644,420, filed 23 Aug. 2002 (the “'420 Application”), now abandoned. The entire disclosures of the foregoing applications are incorporated herein by reference.

### FIELD

Embodiments of the subject matter disclosed herein relate to managing a fleet of remote assets and/or identifying a repair or maintenance for one or more assets.

### BACKGROUND

The management of a large fleet of remote assets, particularly when the fleet of assets comprises a fleet of mobile assets, such as a fleet of trucks, ships or railway locomotives, is a challenging logistical effort. There is continuing pressure for the owners and/or lessors, of such assets to improve the efficiency of operations of the assets to remain competitive in the market place. For example, railroads must manage their fleets of locomotives to increase the on-train time in order to remain competitive with alternative modes of transportation. The assignee of the present application is a supplier of locomotive engines and has developed numerous design features and services to maximize the efficiency of operation of locomotives. The assignee of the present application has also undertaken to provide integrated maintenance services to the owners and/or lessors of automotive assets. Such services may include managing fleet-related data among a plurality of maintenance service centers that supply necessary parts and labor. The coordination of the servicing of a large fleet of mobile assets and the communication with the various parties involved in such efforts are monumental tasks.

U.S. Pat. No. 5,845,272, dated 1 Dec. 1998, describes a system and method for diagnosing failures in a locomotive. While such a system and method has proven beneficial, further improvements in fleet management are desired.

Additionally, operations of mobile assets such as commercial trucks, fleets of leased cars and even private vehicles are generally burdened by overspending on maintenance both in direct costs and in lost productivity of the assets due to unduly conservative maintenance schedules. Such schedules may generally represent the extreme asymmetry in effective cost of planned versus unplanned down time of the mobile assets. Thus, reliable and inexpensive data management services targeted at such assets, and, more specifically, to their operators is desirable. Dynamically and personalized timely delivery of information to operators of the remote assets presents a substantial opportunity for productivity enhancement of the assets, operators and financial investment of the service providers. Location information, as may be available through various navigation systems, such as a Global Positioning System (GPS) and other transponder-based systems, has yet to be leveraged in a systematic manner which enables cost-effective logistics planning, maintenance planning and targeted marketing. Various features available onboard the remote assets have not yet been fully exploited for usage profiling, planning, diagnostics, prognostics or subsystem optimization in the mobile assets. Examples of such features may include computerized control of various subsystems used for operation of the remote assets, e.g., propulsion subsystem, climate control, engine, etc., local and/or remote storage of fault codes and buffering, and storage and data reduction of analog or digital data that such subsystems automatically generate during their operation. The proposed system and techniques of the subject matter described herein are believed to appropriately address the foregoing shortcomings of presently implemented practices.

Maintenance performed on assets and/or vehicles can prolong asset-life and reduce downtime thereof. Conventional techniques often include preventative maintenance to be employed on assets/vehicles, wherein such maintenance is performed based on a manufacturer suggestion (e.g., mileage, duration of time, among others). Yet, each asset or vehicle may require maintenance before or after the manufacturer suggestion in light of, for instance, the amount of use, type of use, environment, among others for the vehicle or asset. For instance, a manufacturer may suggest a duration of time as a trigger for a maintenance procedure but this duration of time may be short (e.g., thus performing the maintenance too soon and increasing cost) or long (e.g., thus performing the maintenance too late and increasing risk for damage).

It may be desirable to have a system and method that differs from those systems and methods that are currently available.

### BRIEF DESCRIPTION

Systems and methods are described herein for effectively integrating the diverse elements involved in the management of remote assets, e.g., a fleet of mobile assets. In one aspect thereof, the inventive subject matter makes use of the data management powers of modem computers and global information networks by using such tools to collect, store, analyze, distribute and present information in a format and at a time when the information can be used most effectively by people responsible for such assets. The terms element, module, and component may refer to computing hardware, such as circuitry that includes and/or is connected with one or more processors (e.g., microprocessors, field programmable gate arrays, integrated circuits, or other electronic logic-based devices).

In one embodiment, the inventive subject matter includes the aspects of real-time data collection from each of the mobile assets, computerized analysis of such data for failure detection and prediction, and the planning of maintenance activities responsive to such failure predictions prior to the asset being taken out of service. The planning of maintenance activities may include the selection of an optimal time and/or location for performing the work, with consideration given to trends in the operating data, the availability of necessary repair resources, and other owner-defined criteria. The various participants and stakeholders in these activities are provided with appropriate levels of information via a global information network. The information presentation power of the multi-media format of an Internet web site may be ideally suited in one embodiment for accomplishing many of the communication functions for implementing the inventive subject matter.

More particularly, a computerized method for identification and evaluation of a repair likely to prevent a failure of a mobile asset is provided. The method allows collecting data indicative of an incipient malfunction in the mobile asset. The method further allows collecting usage data indicative of usage of the mobile asset. The usage data is processed relative to historical data collected from a fleet of corresponding mobile assets to generate a usage profile for that asset. The data indicative of incipient malfunctions is processed to generate a prediction of a failure in the mobile asset and at least one repair likely to prevent the failure of the mobile asset. A repair weight indicative of a probability that the repair will prevent the predicted failure is determined. The repair weight is adjusted based on the usage profile of the asset, and the adjusted repair weight is used to evaluate the repair, for example, to evaluate whether or not the repair should be performed.

In one embodiment, a method is provided that includes evaluating (with at least one component) a portion of sensor data related to an asset, evaluating (with the at least one component) a portion of historic data associated with at least one historic repair to the asset, and indicating (with the at least one component) a future repair to perform on the asset based on at least one of the portion of sensor data or the portion of historic data. The component can include hardware circuitry that includes and/or is connected with one or more processors (e.g., microprocessors, field programmable gate arrays, integrated circuits, or other electronic logic-based devices).

In an embodiment, a system is provided that includes one or more components configured to collect at least one of a portion of sensor data related to an asset or a portion of historic data related to a historic repair performed on the asset. The one or more components can be configured to identify an indicator to perform a future repair on two or more assets based on at least one of the portion of sensor data collected by the one or more components or the portion of historic data collected by the one or more components.

In an embodiment, a system can be provided that includes one or more processors (e.g., microprocessors, field programmable gate arrays, integrated circuits, or other electronic logic-based devices) for evaluating a portion of sensor data related to an asset. The one or more processors can evaluate a portion of historic data associated with a repair to the asset and indicate a repair to perform on the asset based on at least one of the portion of sensor data or the portion of historic data.

### BRIEF DESCRIPTION OF THE DRAWINGS

Reference is made to the accompanying drawings in which particular embodiments and further benefits of the inventive subject matter are illustrated as described in more detail in the description below, in which:

FIG. 1 is a schematic illustration of a communications network for managing a fleet of mobile assets;

FIG. 2 illustrates the steps of a method for managing a fleet of mobile assets;

FIG. 3 is a flow chart embodying one or more aspects of the inventive subject matter;

FIG. 4 is a block diagram representation of an example diagnostic system that may be used for performing the actions described in the context of FIG. 3;

FIG. 5 is a block diagram of a system for communicating data from a mobile asset;

FIG. 6 is a block diagram of the monitoring station apparatus of the system shown in FIG. 5;

FIG. 7 is a block diagram of a vehicle maintenance management method;

FIG. 8 is a block diagram of a system for conducting a remote inbound inspection of vehicles;

FIG. 9 illustrates an apparatus and method for generating work orders;

FIG. 10 illustrates a web page showing a route map for mobile assets;

FIG. 11 illustrates a web page showing the output of a search engine accessible via a global information network identifying the proximity of vehicles to a repair shop;

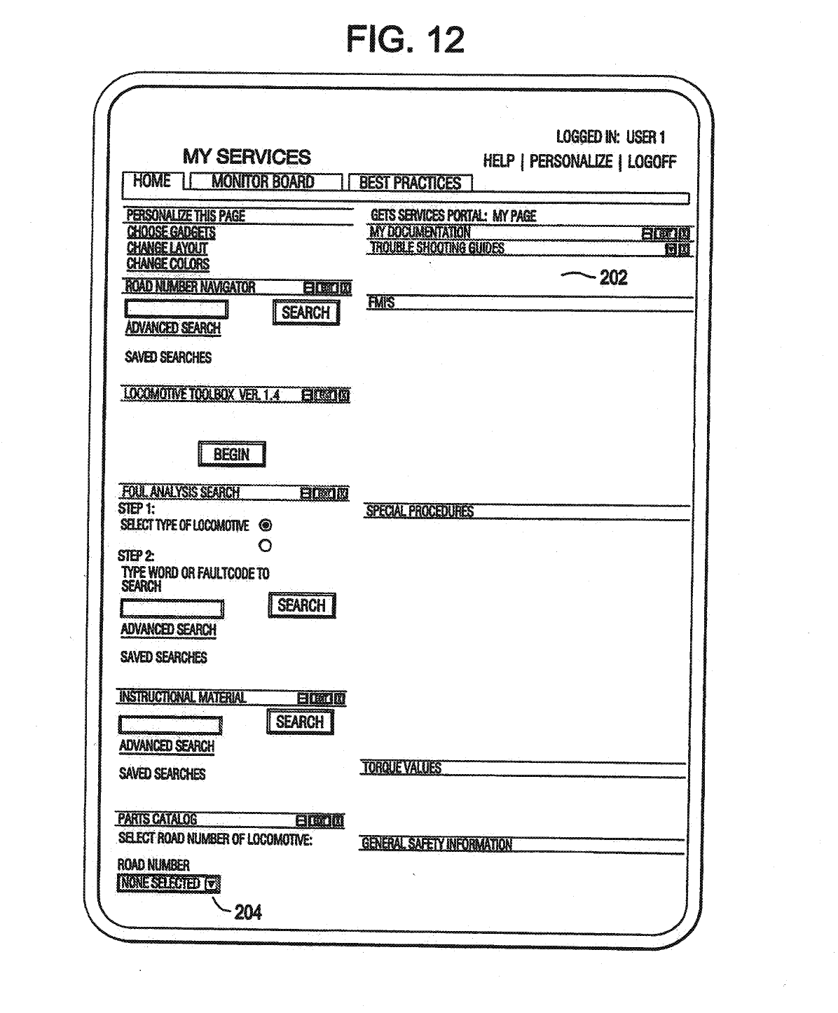

FIGS. 12 through 14 illustrate example pages from a web site including information related to the management of a fleet of vehicles;

FIG. 15 illustrates an example web page that may be used for meeting a contractual obligation to report out on usage of a fleet of vehicles;

FIG. 16 illustrates an example pie chart plot that indicates the amount of time a given set of mobile assets may have spent in respective operational modes indicative of a respective state of health of the assets;

FIG. 17 is an illustration of an embodiment of a system for ascertaining a repair to perform on an asset based on at least one of repair information or sensor data;

FIG. 18 is an illustration of an embodiment of a system for utilizing historic data related to a repair on an asset and sensor data for the asset to indicate a repair to perform on the asset at a particular date or time;

FIG. 19 is an illustration of an embodiment of a system for creating an indicator for an asset which determines a timing for a repair to perform on at least the asset or an additional asset;

FIG. 20 is an illustration of an embodiment of a system for ascertaining a cost associated with a repair to perform on an asset; and

FIG. 21 illustrates a flow chart of an embodiment of a method for identifying a repair to perform on an asset.

### DETAILED DESCRIPTION

Utilization levels of a mobile asset, e.g., a vehicle such as a locomotive or another vehicle, may be used by diagnostic tools to enhance the ability to more accurately and reliably predict a failure and identify an appropriate corrective action, as well as the urgency of the corrective action. Utilization level information may be used on a relative basis by making comparisons to other similar assets within a fleet since, for example, higher utilization levels in a given asset may increase the probability of identifying or recommending a respective repair as well as escalating repair urgency for the asset. Conversely, lower utilization levels may decrease the probability of identifying or recommending the repair as well as avoiding an urgent recommendation for the repair. The diagnostic tools may use relative utilization benchmarking metrics as a factor processed by the tool in order to more accurately capture the underlying causes that may result in malfunctions in the asset. This factor can be used to adjust the repair weight normally provided by the tool. For example, a recommendation may be adjusted into a non-recommendation or vice-versa depending on the level of use of the asset.

To effectively manage a fleet of mobile assets, it may be desired to avoid unexpected equipment failures and to accomplish maintenance and repair activities in a time efficient manner. There is a tremendous amount of information available related to a fleet of mobile assets. Such information may include design information, real time operating data, historical performance data including failure probabilities, parts inventories, and geographic information related to the assets, cargo being transported with the assets, parts, personnel and repair facilities, etc. Key to achieving efficient operation is the ability to communicate such information to people and places where the information is needed, and to present the information in a format that makes the information useful to accomplish the desired result.

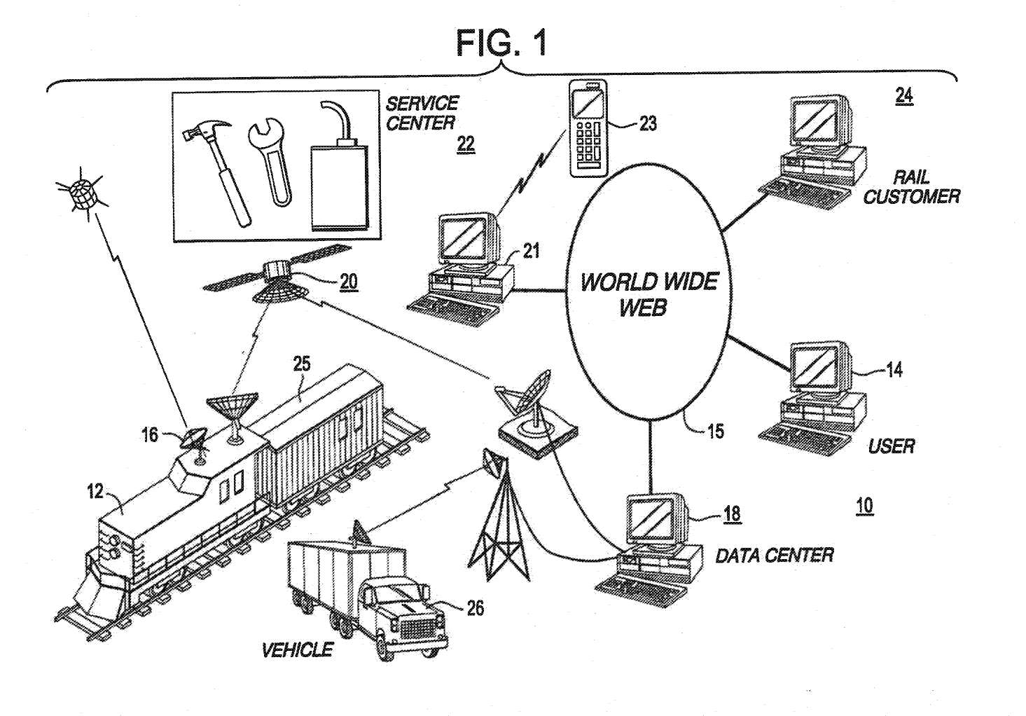

FIG. 1 illustrates an example system for use in managing a fleet of remote assets, which may be used for practicing one or more aspects of the inventive subject matter. Although primarily illustrated and described with respect to a fleet of mobile assets, such as a fleet of vehicles (e.g., locomotives) 12, or a fleet of trucks 26, the inventive subject matter may be implemented with other types of remote assets that may be deployed at a particular site for an extended period of time, such as crane loading equipment based on a port, excavation mining equipment based on a mine, agricultural farming equipment based on a farm, etc. Furthermore, the apparatus and method described herein are useful for managing not only mobile vehicles, but also the cargo transported with such vehicles and dedicated subsystems that may be used for accomplishing the principal utility of the asset, such as the hoisting subsystem that may be used in a “cherry picker” truck, or the refrigeration subsystem used in a refrigerated mobile asset. A data management system 10 allows a variety of different types of users to obtain detailed and timely information regarding each of the mobile assets, e.g., 12 or 26. By way of example, such users may include a transportation company 14 who owns and operates the remote assets, or may include original equipment manufacturers (OEMs) that assemble the mobile asset and lease such assets to respective end users. The users may include a customer 24 or personnel of the transportation company and/or the OEM, personnel in an asset service center 22, personnel in a data center 18, and the engineer or driver that operates each individual asset. The mobile assets, e.g., 12 or 26, may be equipped with a plurality of sensors for monitoring a plurality of operating parameters representative of the condition of the remote asset and of the efficiency of operation of the mobile assets. The mobile assets, e.g., 12 or 26, may also be equipped with a global positioning system (GPS) receiver 16 or other satellite-based or local navigation instrument for determining the geographic location of the mobile asset. Data regarding the location of the mobile asset and operating parameters of the mobile asset may be transferred periodically or in real time to a data base 18 by a data link 20, such as a satellite system, cell phone, optical or infrared system, hard-wired phone line, etc. By way of example, the assignee of the present application operates such a data center 18 at a Monitoring and Diagnostics Service Center (MDSC) in Erie, Pa. Affiliated with such a data center 18 may be one or more service centers 22 where the mobile assets are taken for repair and maintenance services.

As illustrated in FIG. 1, the data center 18 and service center 22 may both be linked to a global information network, such as the Internet 15, by known types of data connections. Such links may typically be a computer interface through an internet service provider. The Internet and World Wide Web provide a means for communicating between the data center 18 and service center 22. Furthermore, these facilities may also be in communication with the transportation company user 14 via an Internet connection. Customers 24 of the transportation company or other members of the public may further be in communication with these facilities through Internet links. Because the Internet 15 and known web page formats provide cost-effective means for communicating data and information in a multi-media format, such a global information network is one example of a useful communication tool for displaying and communicating the large amount of data that may be associated with the operation of a fleet of mobile assets, e.g., 12 or 26.

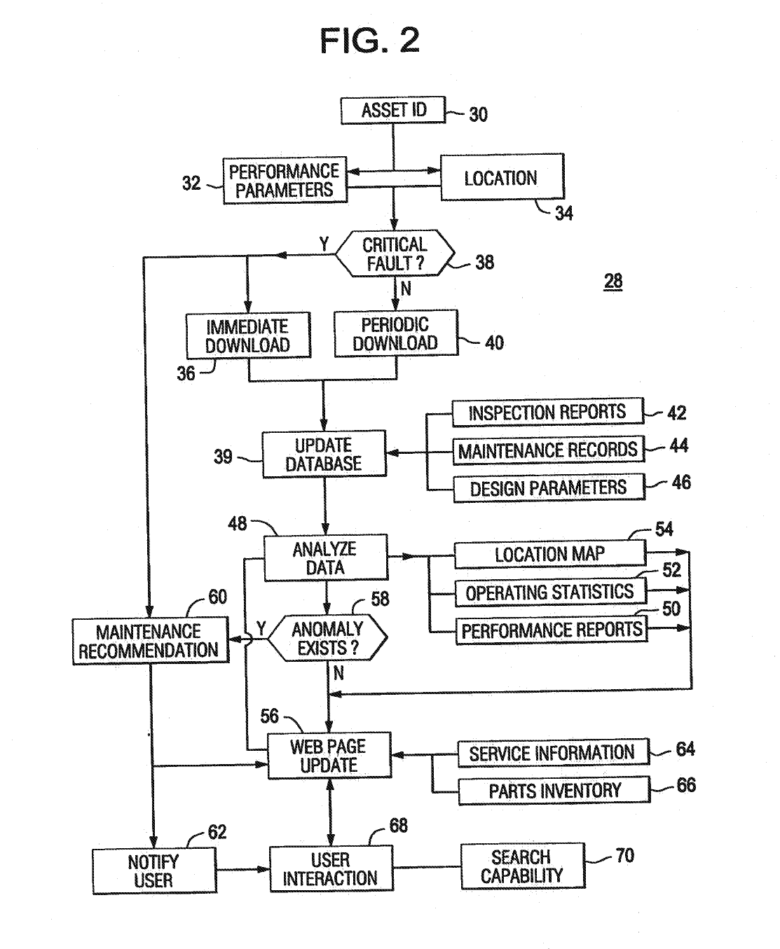

FIG. 2 illustrates example steps of a method 28 for managing a fleet of mobile assets that may be implemented by using a data management system 10 as illustrated in FIG. 1. Each mobile asset may be uniquely identified, such as by an identification number, as in step number 30 of FIG. 2. One or more identifiers may also be associated with the cargo being transported with the mobile assets, e.g., 12 or 26. For respective embodiments of either the fleet of vehicles 12 or the fleet of trucks 26, the operating parameters of each of the mobile assets may be monitored 32 by the on-board sensors. In one embodiment, such operating parameters are monitored in real time, and data related to these operating parameters is available for communication to a data center 18 wherever appropriate. The location of each asset is also determined 34, such as by using a GPS receiver or by otherwise identifying the mobile asset relative to a particular location along the route of the asset. Data regarding both the location and the operating parameters for each mobile asset, e.g., 12 or 26, may be periodically downloaded 36 from an on-board data file to a centralized data base 39. The data may further include environmental conditions to which each mobile asset has been exposed to during their operation. Example of such data may include temperature, barometric pressure, terrain topography, humidity level, dust level, etc. In the event that a critical fault is identified 38 in one of the systems of a mobile asset, data may be downloaded 40 from the mobile asset upon recognition of the fault. The timing of the download may also be determined based upon the availability and quality of the data link 20 between the mobile asset and the data center 18.

The database 39 located at the data center 18 may also include data representing inspection reports 42, maintenance records 44, and design information 46 related to the specific vehicles included in the plurality of mobile assets. For example, if a truck 26 is brought to a service center 22 for a periodic inspection and maintenance visit, e.g., regarding braking equipment of the truck 26, information regarding the results of the inspection and maintenance activities may be used to update the database 39 for that particular truck 26. The database may also be updated 39 if the designer of the mobile asset provides any revised design parameters 46, such as a new part number for an upgraded component. The quantity of data in such a data base may be immense when considering the number of vehicles in some fleets, and when considering the amount of data that may be collected on a periodic basis regarding the performance of each of the vehicles. However, the computing power of modern data processing equipment makes it relatively easy to analyze 48 such a database. Various data processing routines may be used to generate performance reports 50 regarding each of the individual assets or the fleet as an entirety. Statistical data 52 may be calculated to aid in the analysis of the operating parameters of the fleet.

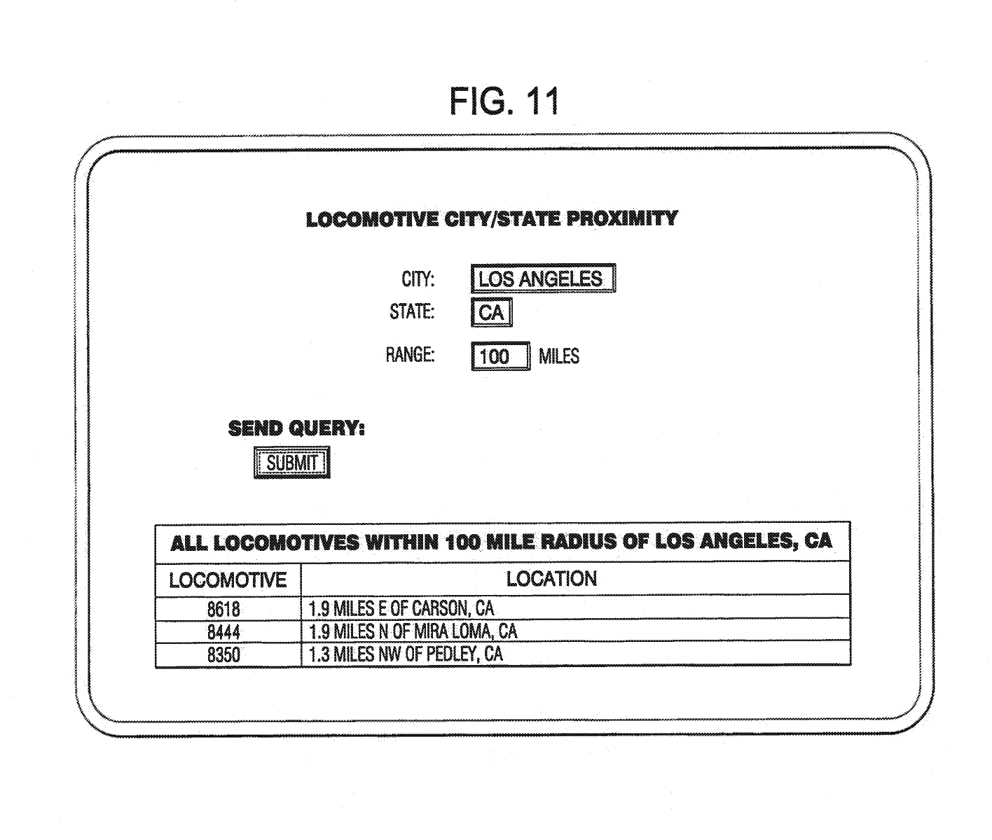

In order to effectively utilize the vast amount of data that may be available regarding a fleet of mobile assets, the output of the analysis 48 of such data may be effectively displayed and conveyed to an interested user 14. As suggested above, there may be multiple users, e.g., users 14 and 24, interested in the data, and the level of detail of interest may vary from time to time. An Internet web page may be an effective way for communicating such data and information. An Internet web page may be updated 56 to reflect the performance reports 50, operating statistics 52, and/or current location map 54 for the fleet of mobile assets. One or more such web pages may be utilized with appropriate hyperlinks to additional web pages. By nesting related web pages, the level of detail presented to the user 14 may be controlled by that user. For example, a location map 190 of FIG. 10 illustrating the current geographic location of each of the assets owned by a rail transportation company may include a hyperlink 192 at the indication of the location of each of the vehicles 12. Such a map may also illustrate the location of service facilities, in the context of a fleet of trucks, a road map may be generated showing the location of each truck along with a route. By constructing such a map in a web site format, a hyperlink 192 may be provided on the map for each mobile asset to connect the user to an interconnected nested web page including additional information regarding that particular vehicle. For example, while the location of the mobile asset may be seen on map 190, by double clicking a cursor on the symbol for a single mobile asset, the speed, destination, route, cargo information, fuel level, driver information, and other operating information for that mobile asset may be viewed on nested web pages. One user, such as a customer 24 of the transportation company, may only be interested in the location of the truck. Another user 14, such as a service technician employed by the railroad, may be interested not only in the location of the locomotive but also in the amount of fuel on board or other operating parameter. Any such users, e.g., 14 or 24, can quickly obtain the information needed by the users by a simple point and click operation using known Internet browser technology.

A search engine software technology may be provided 70 to allow a user 10 to identify desired information related to the mobile assets 12 via the global information network 15. Access to an appropriate web page including the desired information may then be provided via hyperlink directly from the search engine.

An Internet web page display used with the inventive subject matter described herein may incorporate the full power of the multi-media capabilities of a global information network 15. For example, the location map 54 may include the use of color to indicate a readiness status for each mobile asset, for example, green for a properly functioning mobile asset, yellow for a mobile asset exhibiting an anomaly in one of the operating parameters of the mobile asset, and red for a mobile asset having a critical fault. The user 14 of such information would be able to quickly assimilate a large volume of data and to have his/her attention directed to important portions of the data. Such a web page may also include links to additional pages including drawings of component parts, specifications, or operating and repair manuals or other design parameters 46. In some instances, it may be advantageous to include video information on such a web site, such as still or animated video produced by the operator of the locomotive and transmitted directly from the mobile asset to show the condition of a component. Such video information may be accompanied by live audio information, including speech from the operator, thereby allowing the user 14, the operator located on the mobile asset, and personnel at a service center 22 to conference regarding a developing anomaly. Communication over the global information network 15 using Internet Protocol allows packets of data to be communicated between different kinds of networks. The packets may consist of voice, text, video, audio or other types of data. The system 10 of FIG. 1 is adaptable to make use of future platforms as the platforms become available.

Responsive to identification 38 of a critical fault, or an anomaly is found to exist 58 in one or more of the operating parameters, a service recommendation may be developed 60. Information regarding the anomaly 58, critical fault 38, and/or service recommendation 60 may also be uploaded 56 to an Internet web page. When appropriate, a user may be notified 62 that new or urgent information has been displayed on the Internet web page. The user may be notified 62 by an electronic mail message, telephone call, text message, fax, or other simple form of communication. The user may then actively interact 68 with the web pages that present data regarding the mobile asset of interest. Such interaction may include a request by the user for additional information. Such a request would be transmitted to the operator of the mobile asset or other appropriate person via the global information network connection, and the response would be communicated in return.

The information available to the user on the Internet web page may also include information regarding services that are available 64 and/or a parts inventory 66 that may be important to any decision regarding a maintenance recommendation 60. Personnel located at a service center 22 may not only provide data for the user 14, but may also receive a communication from the user 14 regarding a planned maintenance activity, thereby facilitating the scheduling of maintenance activities at the service center 22.

One advantage of the data management system 10 of FIG. 1 and method 28 of FIG. 2 may be appreciated by considering a three locomotive train 12 operating in a relatively flat terrain on the way to a mountainous section of a rail line. Because the three locomotives are operating at reduced capacity along the flat terrain, the operator of the locomotives who may be physically sitting in the front locomotive may not be aware that a degraded condition has developed in the third locomotive. For example, a degraded cooling system may cause the third locomotive to throttle back to a reduced power output. Because the first and second locomotives are able to provide the necessary power, the progress of the train is unimpeded. Should this degraded condition continue to go unnoticed, the train would be unable to negotiate the mountainous terrain that the train is approaching later in the journey. On-board sensors on the third locomotive identify the degraded cooling condition and data related to the degraded condition is downloaded 40 to the data center 18 to update the data center database 38. Computers and/or personnel located at the data center 18 may analyze the data 48 and identify that the anomaly exists 58 and determine that a maintenance action 60 is recommended. For example, if a fan motor controller has developed a malfunction, a maintenance recommendation 60 to replace the control panel may be generated. A web page display showing the location of the locomotive would then be promptly updated 56 to show the degraded condition, and the railroad maintenance personnel are notified 62 by an electronic mail message that is automatically generated at the data center 18. The e-mail will include a Universal Resource Locator (URL) directing the maintenance personnel to an Internet web page including information regarding the degraded condition and the recommended maintenance activity. The maintenance personnel then view the available parts inventory 66 illustrated on another web page to verify the availability of the required control panel in a service center 22 located along the route of the locomotive 12. In this example, a user 14 is able to utilize the power of a global information network 15 web page presentation to quickly assess the importance of anomaly affecting one of a fleet of mobile assets and to assess various options for addressing such anomaly. For this example, the degraded locomotive may be repaired prior to the train becoming stalled on a mountainous section of the track, thereby avoiding a large out-of-pocket expense and a costly schedule delay for the transportation company. The speed of communication via the Internet and the breath of information that may be effectively communicated via an Internet web page make the system 10 of FIG. 1 and the method of managing assets 28 of FIG. 2 beneficial for a large fleet of mobile asset distributed over a large geographic area.

Access to an Internet web page including important information regarding a fleet of mobile assets may be restricted to only those users having appropriate authorization to access such data. For example, information derived from the analysis 48 of the data base may be displayed on a password protected Internet web page. Only authorized users, e.g., 14 or 24, would then be provided with the password necessary to gain access to the web page. Similarly, information received from a user and used to update the web page 56 may only be accepted as authentic if the user enters an appropriate password to confirm his/her identity. Other protection measures such as encrypting data may also be used. In some cases, it may be desired to have at least a portion of the information displayed on an Internet web page be made publicly available. For example, it may be desirable to make the location map 54 for at least a portion of the mobile assets available for public viewing. In the case of a passenger and/or freight transportation company, the location of autobuses may be information that can be made available on a public Internet web page, whereas the location of freight trucks may be limited to only specific industrial customers of the transportation company.

One or more embodiments of the systems and methods described herein may predict equipment failure and use such a prediction to plan repair and/or maintenance work for each individual asset. Once data is collected from the mobile assets, the collected data may be used to develop a variety of types of information regarding the mobile assets. Such a capability includes monitoring on-board fault log data and/or operational parameter data transmitted from each mobile asset as the mobile asset is operating, determining whether any of the monitored data is out of a predetermined range, calculating trends for monitored data and projecting a time estimate as to when the monitored data is likely to be out of range, identifying any equipment fault, predicting when such equipment is likely to fail unless corrected, predicting which, if any, equipment must be corrected to avoid mobile asset failure, developing a service recommendation, and communicating the service recommendation via a global information network.

Mobile assets, such as locomotives, may be serviced in two ways: regularly scheduled maintenances which occur on a periodic basis and service calls which are issued for problems that indicate imminent failures between regularly scheduled maintenances.

The utilization of a given locomotive, subject to a given traffic scheduling and the particular application for which a locomotive is used for by a railroad enterprise, may dictate a non-static method of servicing a locomotive. For example, a locomotive that is used relatively infrequently and/or for lighter-load service may not require as frequent servicing as a locomotive with more frequent use and/or for heavier-load service. Using the same example, diagnostics issued between regularly scheduled maintenance may not require as much urgency as compared to another locomotive used in more demanding applications. Aspects of the inventive subject matter provide processes aimed at solving these traditional deficiencies in locomotive servicing and diagnostics.

Dynamic Locomotive Scheduling:

Using a process to measure the relative utilization of a locomotive and type of service allows creating a dynamically generated heuristic technique to project the appropriate number of days between scheduled shoppings. By way of example, locomotives may be on a standard 92-day scheduled shopping cycle. This may be dynamically adjusted to improve quality of service and cost of shopping to reflect the actual servicing needs of the mobile asset.

For example, an assets' utilization may be characterized by the following notch level usage data (e.g., throttle command settings) over a given time period:

Usage

| | |
|---|---|
| Notch 1 | .02 |
| Notch 2 | .03 |
| Notch 3 | .02 |
| Notch 4 | .03 |
| Notch 5 | .02 |
| Notch 6 | .07 |
| Notch 7 | .06 |
| Notch 8 | .08 |
| Total Use | 33% |

An example time period of analysis can be one month and that the type of service is to move cargo can be categorized as heavy-cargo. The average utilization for a locomotive in this fleet based on historical data may be 27%, and that each locomotive in this fleet is used for the same type of application (e.g., hauling heavy-cargo).

In one embodiment, a dynamically generated shop cycle period based on asset utilization may be computed as follows:

((1−A)*B=)*C=cycle period

where A=% utilization (e.g., 33%), B=Standard Shopping Cycle (e.g., 92 days) and C=scaling factor for a given level of service.

Assuming C=1.3 for heavy-cargo service and 1.5 for light-cargo, then, the dynamically generated shopping period in this example would be:

(0.67*92)*1.3=˜80 day period.

Thus, in the foregoing example, the shopping cycle would be reduced to approximately an 80 day period in lieu of the standard 92 shopping cycle.

Similarly, assuming 25% utilization for a light cargo application, then the dynamically generated period for this additional example would be:

(0.75*92)*1.5=103.5 days

Thus, in the foregoing example, the shopping cycle would be increased to approximately a 103.5 day period in lieu of the standard 92 shopping cycle.

The above-identified mathematical relationships represent an example version based on a binary categorization of asset utilization to illustrate the core conceptual principles. In practice, the mathematical relationships could be configured to more finely account for multi-level asset utilization, in lieu of just light and heavy use.

Prognostics Tools Incorporating Utilization Heuristics:

Prognostics tools (or predictive diagnostics or diagnostics tools) may just take into account presently available fault and/or operational parameter data in order to make a probabilistic determination of a relationship between a predicted failure, and a likely corrective action to prevent occurrence of the failure. One example of diagnostics tool and techniques is provided in U.S. patent application Ser. No. 09/285,612, assigned to the same assignee of the present application, which patent application discloses system and method for processing historical repair data and fault log data and provides weighted repair and distinct fault cluster combinations to facilitate analysis of new fault log data from a malfunctioning machine. Further, U.S. Pat. No. 6,343,236, assigned to the same assignee of the present application, discloses system and method for analyzing new fault log data from a malfunctioning machine wherein the system and method predict one or more repair actions using predetermined weighted repair and distinct fault cluster combinations. Additionally, U.S. Pat. No. 6,336,065, assigned to the same assignee of the present application, provides systems and methods that use snapshot observations of operational parameters from a machine in combination with fault log data in order to further enhance the predictive accuracy of the diagnostic algorithms used therein. Moreover, U.S. patent application Ser. No. 09/688,105, assigned in common to the assignee of the present application, provides processes and systems that use anomaly definitions based on continuous parameters to generate diagnostics and repair data. The anomaly definitions in this case are different from faults in the sense that the information can be taken in a wider time window, whereas faults, or even fault data combined with snapshot data, are generally based on generally discrete behavior occurring at one instance in time. The anomaly definitions, however, may be analogized to virtual faults and thus, such anomaly definitions can be learned using the same diagnostics algorithms that can be used for processing fault log data. Each of the foregoing applications is incorporated herein by reference in their respective entirety.

Utilization levels of a mobile asset, e.g., a locomotive, may be used in such diagnostic tools to enhance their ability to more accurately and reliably make a prediction of the failure and identify the corrective action as well as the urgency of the corrective action. Utilization level information may be used on a relative basis by making comparisons to other similar assets within the same fleet as well as higher level comparisons of relative usage, such as comparison to other same-family assets used for different applications.

Higher utilization levels in a given asset may increase the probability of identifying or recommending a respective repair as well as escalating repair urgency for the asset. Conversely, lower utilization levels may decrease the probability of identifying or recommending the repair as well as avoiding an urgent recommendation for the repair. Diagnostic tools may use relative utilization benchmarking metrics, as illustrated in the foregoing examples as a factor processed by the tool in order to more accurately capture the underlying causes that may result in malfunctions in the asset. This factor can be used to adjust the repair weight normally provided by the tool. For example, a recommendation may be adjusted into a non-recommendation or vice-versa depending on the level of use of the asset.

### EXAMPLE

A high pressure pump may have an actual repair weight of 0.23. Analysis of fault log data and/or operational parameters performed by the diagnostics tools generates the repair weight of 0.23. The pump may be used in an underutilized locomotive. Comparison of utilization data of that locomotive relative to a reference frame of utilization based on fleet utilization data of similarly equipped locomotives indicates that the locomotive is underutilized.

Since the above repair weight is based on data for an underutilized locomotive, the actual repair weight of 0.23 may be adjusted as follows. With a repair weight of 0.27 for locomotives subject to average use, in this case the ratio of the actual repair weight relative to the average repair weight of 0.27 yields an adjusting factor of (0.23/0.27)=0.85. The adjusting factor is multiplied by the original repair weight of 0.23 to generate an adjusted repair weight of 0.85*0.23=0.19. If the diagnostic tool output threshold for issuing a repair for the pump is 0.2, then, in this case, the tool would not have recommended any corrective action for this underutilized locomotive. The above example illustrates that the usage profile of the locomotive may be used to adjust the repair weight supplied by the diagnostic tool (e.g., the systems and methods described herein).

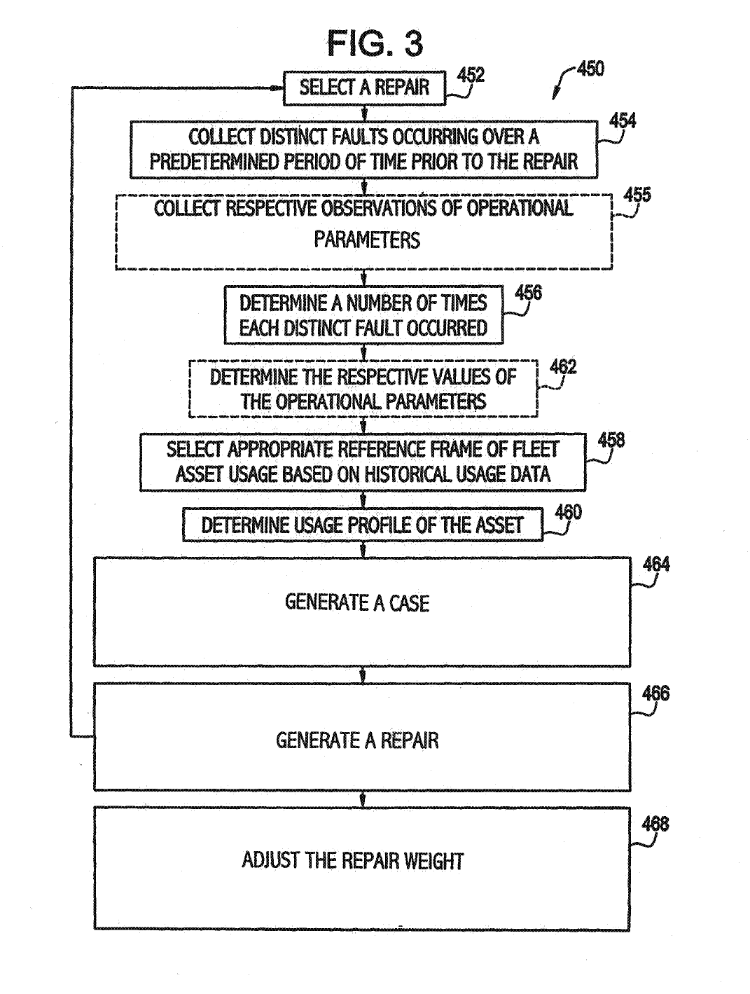

FIG. 3 illustrates a flowchart of an example process 450 for selecting or identifying a repair based on fault log data and usage profile of a mobile asset. The selection or identification of the repair may be optionally based on operational parameter data. Process 450 may be used for generating a plurality of diagnostic cases, which include at least one repair likely to prevent a predicted failure in the mobile asset. Each repair may include a repair weight and/or a level of criticality or urgency associated with the repair. As used herein, the term “case” comprises a repair based on one or more distinct faults or fault clusters in combination with the usage profile of the asset. As suggested above, the case may be enhanced with operational parameter data if so desired.

With reference to FIG. 3, the process 450 comprises, at 452, selecting initiation of a repair for a mobile asset. Upon initiating the repair, one may search a fault log data storage unit to collect, at 454, distinct faults occurring over a predetermined period of time prior to the repair. Similarly, an operational parameter data storage unit may be optionally searched to collect, at 455, respective observations of operational parameter data occurring over a predetermined period of time prior to the repair. The observations may include snapshot observations, or may include substantially continuous observations that would allow for detecting trends that may develop over time in the operational parameter data and that may be indicative of malfunctions in the machine. The predetermined period of time may extend from a predetermined date prior to the repair to the date of the repair, e.g., 14 days prior to the date of the repair. Optionally, other suitable time periods may be chosen. The same period of time may be chosen for generating all of the cases.

At 456, the number of times each distinct fault occurred during the predetermined period of time is determined. An appropriate benchmarking of mobile asset usage relative to other similar assets in a fleet may be selected. This would allow at 458 to select a reference frame of fleet asset usage relative to other similar assets based on historical data. For example, such an action may allow establishing the relative usage of an asset including a particular type of propulsion system relative to other assets in a fleet equipped with that type of propulsion system.

At 460 one is able to determine the usage profile of the asset. For example, this would allow quantitatively determining whether the mobile asset equipped with the particular type of propulsion system has been underutilized or overutilized relative to a reference frame of fleet utilization for mobile assets equipped with that type of propulsion system. At 462, the respective values of the observations of the operational parameters may be determined, assuming operational parameters are used. A case comprising the repair, the one or more distinct faults, the usage profile, and, if desired, the respective observations of the operational parameters is generated and stored, at 464. For each case, at least one repair including a repair weight and/or a level of repair criticality based on the distinct faults and usage profile, and further optionally based on the observations of the operational parameters may be generated at 466. At 468, the repair weight may be adjusted based, at least in part, on the usage profile of the asset to generate an adjusted repair weight. As suggested above, the repair weight may be advantageously used for determining whether or not the repair should actually be performed.

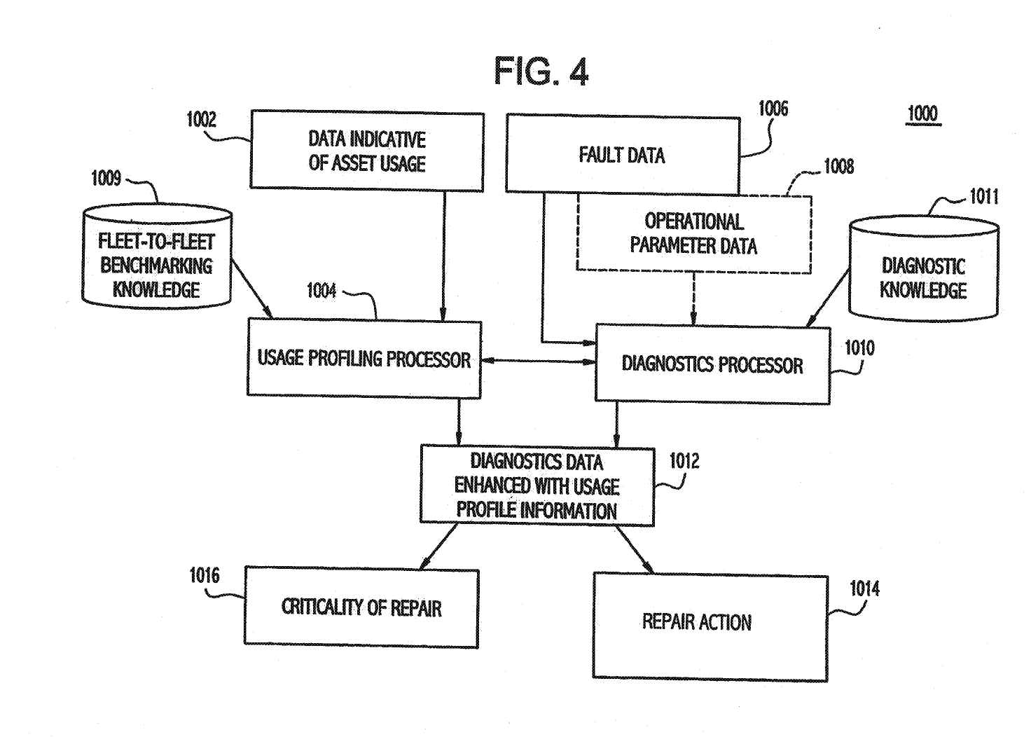

FIG. 4 is a block diagram representation of an example diagnostic system 1000 that may be used for performing the actions described in the context of FIG. 3. The system optionally may be referred to as a diagnostic tool. As suggested above, system 1000 utilizes usage profiling together with mobile asset data (e.g., fault log data and/or operational parameter data) to even more precisely and reliably identify a repair, generate a repair weight indicative of a probability that a selected repair will prevent a predicted failure in the mobile asset, and adjust the repair weight based, at least in part, on the usage profile of the asset to generate an adjusted repair weight. The adjusted repair weight can be used for determining whether or not the selected repair should actually be performed. Further, the usage profile of the asset may be used to indicate a level of criticality or urgency regarding that repair. Data indicative of asset usage 1002 is provided to one or more usage-profiling processors 1004 coupled to a database 1009 that, for example, may store fleet-to-fleet benchmarking knowledge, such as may be based on historical data of similarly equipped locomotives in a fleet. Fault log data 1006 and, optionally, operational parameter data 1008 may be provided to one or more diagnostics processors 1010 coupled to a database 1011 configured to store diagnostic knowledge. The respective processors 1004 and 1010 are configured to generate data 1012 indicative of diagnostics enhanced with usage profile information that allows identifying a repair 1014 and determining an adjusted repair weight and/or a criticality of repair 1016. For example, assuming there is fault log data indicative of an incipient malfunction in a low-pressure pump, then, depending on the usage profile of the asset, a determination may be made not just to repair the low-pressure pump but also to escalate the urgency of the repair to a high degree, if, for example, the level of usage of that asset is high. Conversely, if the level of asset usage is relatively low, then the level of criticality of the repair may be designated as moderate. The term “processor” can refer to hardware circuitry that includes and/or is connected with one or more electronic logic-based devices, such as microprocessors, field programmable gate arrays, integrated circuits, or the like.

As suggested above, data that may be optionally used to enhance the diagnostics analysis may include operational parameter data indicative of a plurality of operational parameters or operational conditions of the mobile asset. The operational parameter data may be obtained from various sensor readings or observations, e.g., temperature sensor readings, pressure sensor readings, electrical sensor readings, engine power readings, etc. Examples of operational conditions of the asset may include whether the locomotive is operating in a motoring or in a dynamic braking mode of operation, whether any given subsystem in the locomotive is undergoing a self-test, whether the locomotive is stationary, whether the engine is operating under maximum load conditions, etc. Devices such as a repair data storage unit, a fault log data storage unit, and an operational parameter data storage unit may be used to data repair data, fault log data and operational parameter data for a plurality of different locomotives. The operational parameter data may be made up of snapshot observations, e.g., substantially instantaneous readings or discrete samples of the respective values of the operational parameters from the locomotive. The snapshot observations may be temporally aligned relative to the time when respective faults are generated or logged in the locomotive. For example, the temporal alignment allows for determining the respective values of the operational parameters from the locomotive prior, during or after the logging of respective faults in the locomotive. The operational parameter data need not be limited to snapshot observations since substantially continuous observations over a predetermined period of time before or after a fault is logged can be similarly obtained. This feature may be particularly desirable if the system is configured for detection of trends that may be indicative of incipient failures in the locomotive.

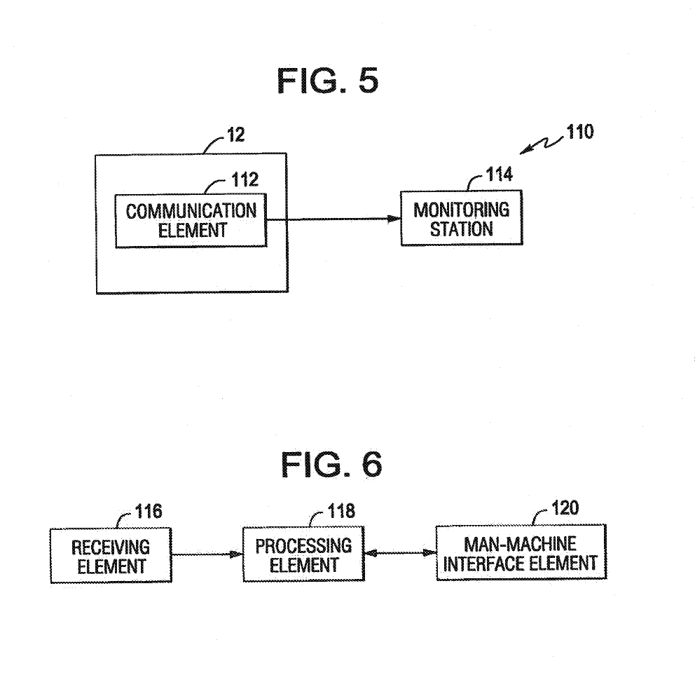

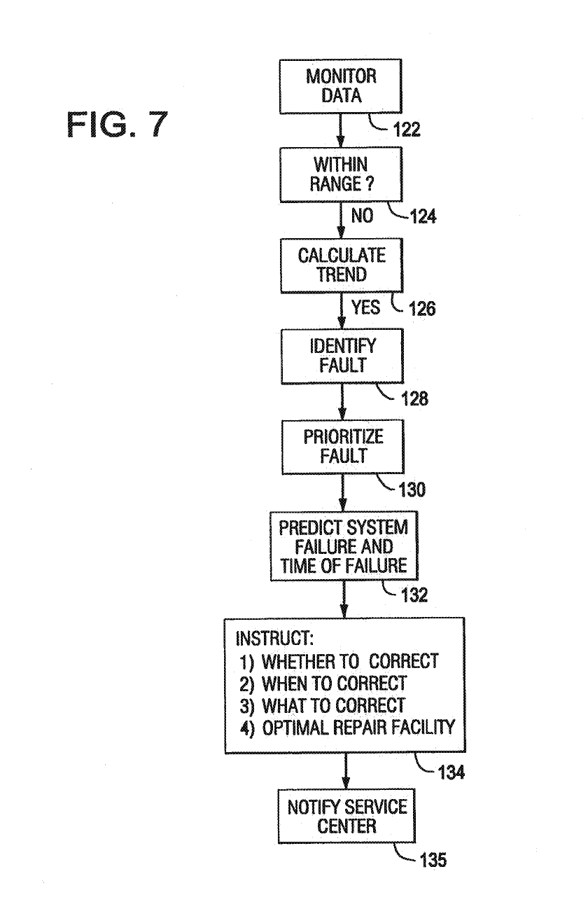

An apparatus configured to accomplish communication actions is generally identified by numeral 110 of FIG. 5, and the apparatus comprises one or more communication elements 112 and a monitoring station 114. The communication element(s) 112 are carried by the remote vehicle, for example, a locomotive 12 or truck. The communication element(s) may comprise a cellular modem, a satellite transmitter, or similar devices or methods for conveying wireless signals over long distances. Signals transmitted by communication element 112 are received by monitoring station 114 that, for example, may be the maintenance facility 22 or data center 18 of FIG. 1. Monitoring station 114 includes appropriate hardware and software for receiving and processing vehicle system parameter data signals generated by locomotive 12 or truck 26 from a remote location. Such equipment, as illustrated in block diagram form in FIG. 6 can comprise receiving element 116, processing element 118, and man-machine interface element 120.

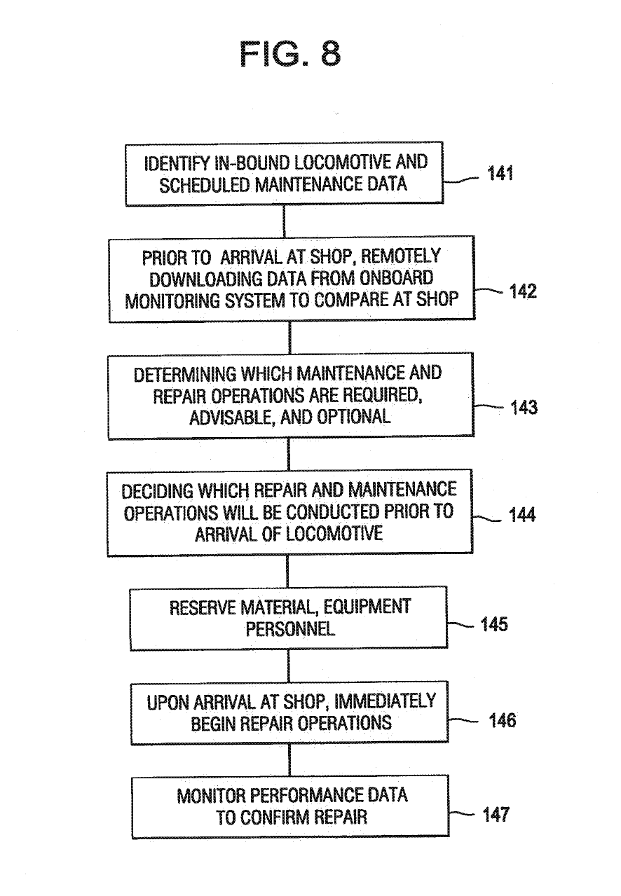

Examples of suitable receiving element 116 include a satellite communications receiver or cellular communications receiver. Processing element 118 may comprise a processor, memory and modem or Integrated Services Digital Network (ISDN) adapter of a conventional personal computer or workstation coupled with software capable of executing the functions represented in FIG. 6. Suitable processing element 118 may include a diagnostic system as described in U.S. Pat. No. 5,845,272. Man-machine interface element 120 may include a monitor, keyboard, mouse, printer and/or other related input and/or output (I/O) devices for enabling interaction between a human operator and processing element 118. Monitored vehicle parameter data received by receiving element 116 is communicated to processing element 118, where the data is processed in the manner shown in FIG. 7. In one embodiment, processing element 118 may be installed onboard the remote asset. In such embodiment, in lieu of transmitting raw data from the remote asset to the data center, the data will have been processed onboard by processing element 118. This embodiment may be less vulnerable to data link outages that may occur from time to time or data link data handling capacity. Further, such embodiment would allow for informing the operator in real time of any appropriate actions that the operator should take in connection with the operation of the mobile asset.

Many vehicle system operating parameters are monitored, and trends are calculated on a subset of those parameters, or on all of the parameters. Among the parameters which may be monitored for vehicles are ambient air temperature, train notch, total track and force power, total voltage, total amps, software versions, engine revolutions per minute (RPM), engine temperature, crankcase pressure, dynamic braking, battery voltage, and voltage and amperage for all auxiliary motors. For other vehicles, such as trucks, other sets of parameters may be monitored. In one embodiment, data that may be monitored may comprise data from the vehicle “control system,” including onboard diagnostics (OBD), speedometer electronic output, brake state and other data feeds available from various vehicles subsystems. The monitored data may be used to determine a respective mobile asset “operating mode”, as described in greater detail below. The monitored data may be accumulated or counted to determine the amount of time each respective mobile asset has been in any given operating mode, and to determine changes and severity level in the operational modes. Examples may include braking severity and severity of acceleration. Correction factors based on ambient conditions, such as temperature, humidity, etc., may be incorporated to more accurately calculate the most suitable operational mode to be assigned. The processing elements may be configured to provide data useful to determine maintenance actions appropriate to the actual operational conditions of any given asset. Examples of the processing of such condition-based data may include respective data processing routines for determining: remaining life of oil, filters, rings, engine, brakes, etc. Other applications may include determining OEM used vehicle certification criteria, supporting insurance actuarial modifications, etc.

One example matrix for determining the operational mode of the mobile asset may be as illustrated in Table 1, wherein a steady state condition may correspond to meeting a respective set of rules, such as the following example set of rules:
Steady State Stable engine block temperature, e.g., inferred from oil temperature, Time of operation and ambient conditions for applicable vehicle model; and/or Stable Coolant Temperature; & Not braking; & Not Accelerating; & Not Shifting; & Not Climbing or descending

It should be noted that in the general case, each operational mode may be derived from a multi-dimensional matrix. For simplicity of illustration, in Table 1, only a first dimension is listed. Other dimensions may comprise ambient conditions, engine temperature state, vehicle weight, vehicular load including wind and incline. For example, a vehicle may be in the state Accelerate Low/Up steep hill/into headwind/hot ambient/hot engine, which may indicate a life consumption adjusting factor on the oil ten times normal depletion, e.g., as compared to depletion in an ideal steady state cruising. The adjusting factors may be experimentally and/or empirically determined in combination with oil analyses, dynamometer measurements, and engine and vehicle models. Table 1 below illustrates example operational or operating modes that may be accumulated to determine the actual historical usage of the vehicle. Table 2 below illustrates an actual mobile asset usage history.

TABLE 1
Vehicle Operating Modes

| Vehicle | Vehicle | M & D Integer |
|---|---|---|
| Mode | Condition | Mode Value |
| OFF/Unknown | Transient | 0 |
| Idle | Transient | 1 |
| Accelerate-LO | Transient | 2 |
| Accelerate-HI | Transient | 3 |
| Braking-HI | Transient | 4 |
| Braking-LO | Transient | 5 |
| Idle with Aux. | Transient | 6 |
| Low Speed | Transient | 7 |
| Medium Speed | Transient | 8 |
| High Speed | Transient | 9 |
| High Speed Climbing | Transient | 10 |
| Descending | Transient | 11 |
| High Torque | Transient | 12 |
| Idle with Aux. | Steady State | 13 |
| Low Speed | Steady State | 14 |
| Medium Speed | Steady State | 15 |
| High Speed | Steady State | 16 |
| High Speed Climbing | Steady State | 17 |
| Descending | Steady State | 18 |
| High Torque | Steady State | 19 |

TABLE 2
Actual Mobile Asset Usage History
Vehicle Usage History

| | |
|---|---|
| Starts | Hours |
| Normal | City Driving |
| Cold | Idle Time |
| Hot | Highway |
| Stalls | High Torque |
| Load Cycles | Seasons |
| Day, Night | Winter v. Summer |
| Weekend Usage | |

Referring to FIG. 7, there is shown a block diagram of the operations performed by processing element 118 upon receipt of vehicle systems parameter data transmitted by communication element 112. As suggested above, some embodiments may allow for performing most or all of such processing onboard the mobile asset. Upon issuance of a transmission request from monitoring station 114, communication element 112 may continuously transmit the data and receiving element 116 may continuously receive the data. Using receiving element 116, processing element 118 monitors the data as indicated at 122. A first determination 124 made by processing element 118 is whether any of the data is outside of an acceptable range for any of the vehicle systems being monitored. If the processing element identifies out-of-range data, the processing element executes a routine 126 to calculate whether the data suggests one or more trends suggestive of possible or actual impairment or failure of the vehicle systems being monitored.

The trends are calculated by comparing values for a given parameter over a period of time and comparing those values with historical data for identical vehicle systems. This enables rapid and accurate correlation of trending data with a dedicated fault occurrence experience database. The trends can be calculated based in part on prior downloads collected in the database. The database can be continually updated and may be stored in the memory of processing element 118, elsewhere at the monitoring station 114, or off-site where the database may be accessed on-line.

An example of a trend that may indicate a system fault would be a crankcase overpressure trend from negative to positive. Such a condition may be suggestive of a cylinder or piston problem or excessive engine wear. Processing element 118 can link the results of several observed trends to more precisely diagnose a problem. For instance, the aforementioned crankcase overpressure trend may be coupled by processing element 118 with an observed trend in electronic fuel injection parameters to more clearly determine the cause of the problem.

Once an unfavorable trend is detected, the trend is identified by processing element 118 with a stored fault code as indicated at 128. Fault codes corresponding to a wide variety of faults may be stored, and trends may be calculated for some or all of them. Examples of faults that may be categorized include, without limitation, overcurrents, flashovers, crankcase overtemperatures, crankcase overpressures, communication failures, electrical ground failures, air conditioner converter failures, propulsion system faults, auxiliary system faults, propulsion motor faults, auxiliary motor faults, auxiliary system charging faults, engine cooling system faults, oil system faults, control wiring faults, and microelectronics faults.

As indicated at 130, following identification and categorization of a fault, processing element 118 can prioritize the fault. The fault prioritization process involves comparing the identified fault code with a historical fault database whereby the fault may be classified as critical, restrictive, or both critical and restrictive. A critical fault is one that will cause imminent vehicle shutdown if not immediately corrected. Examples include, without limitation, serious engine problems, main and auxiliary alternator grounds, coolant or oil pressure loss and microelectronics failures. A restrictive fault is one that, although not likely to cause imminent vehicle shutdown, impedes vehicle performance. A restrictive fault is likely to become progressively worse and may degenerate into a critical fault if not timely addressed. Examples of restrictive faults include, without limitation, an overheated engine or the loss of one or more cylinders, each of which deplete horsepower and may cause other strain on the engine or other systems of the vehicle.

After a fault has been prioritized, processing element 118, as indicated at 132, predicts which vehicle system is likely to fail. Additionally, processing element also predicts the estimated time of failure, which may be expressed as an approximation of the distance (in miles or kilometers, for example) the vehicle can be safely operated before the vehicle must be shopped prior to failure or the amount of operating time prior to failure. The optimum time the vehicle should be shopped is determined by resorting to the relevant trend data for the identified fault and comparing that data with a projected time-of-failure knowledge base which has been inputted into the database for the calculation.

As indicated at 134, processing element 118 can be programmed to instruct a human operator at monitoring station 114: (1) whether to correct the fault prior to scheduled maintenance of the vehicle, (2) when to correct the fault, (3) what fault to correct (which may include what parts or components of the vehicle to repair), and (4) the optimal facility at which to correct the fault. The optimal repair facility is dependent upon the proximity of the vehicle to a facility and whether the facility has the capability, including parts, service equipment and personnel expertise necessary to repair the fault. Personnel at the service center are alerted to the planned arrival of the mobile asset at step 135.

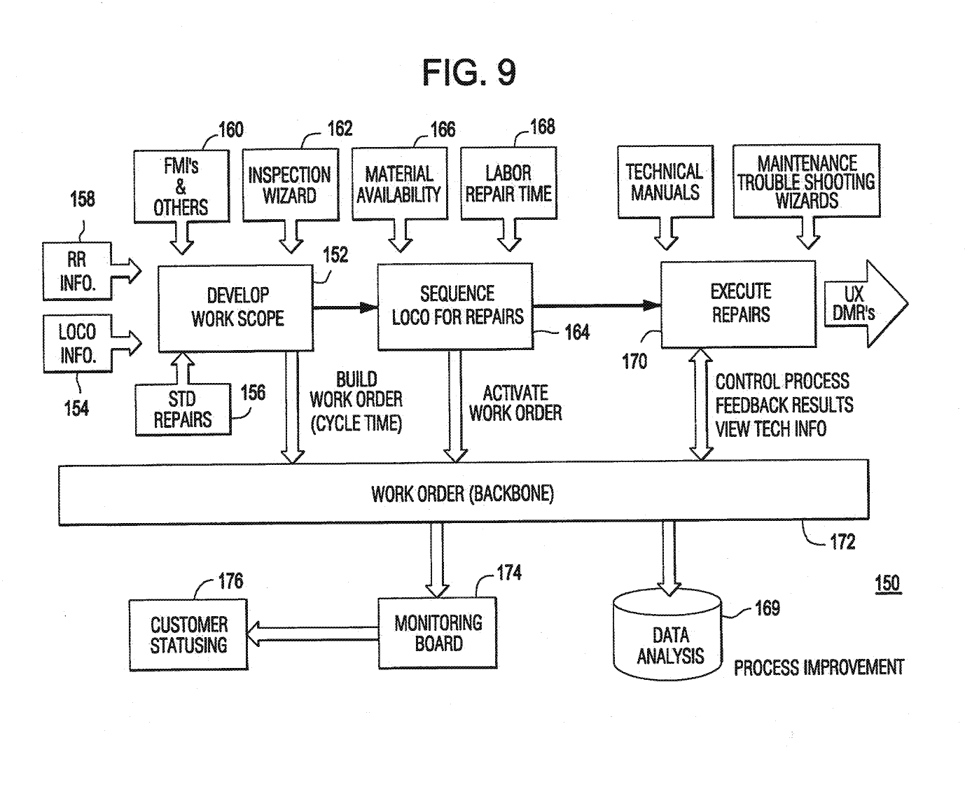

The data monitored at step 122 may include data regarding the cargo 25 being transported by a mobile asset 16. Such data may be used to develop information regarding the cargo, and such information may be distributed via the global information network 15. A web site may be developed including information of interest to the owners of the cargo 25, such as the location of the cargo, and such owners may be provided access to the respective web pages via secured or unsecured web access via the global information network 25. A route map such as is illustrated in FIG. 8 may be posted on the global information network 15 to illustrate the location of various cargo loads. Two-way communication may be provided between a controller 24 for the operation of the mobile assets 16 and the owners 14 of the cargo 25.

The apparatus and method embodying aspects of the inventive subject matter also may include improvements in the processing of a mobile asset through the repair facility 22 of FIG. 1 when maintenance/repairs are necessary. FIG. 8 illustrates in block diagram form a system for performing an inspection of a remote inbound vehicle, and for planning the maintenance/repair activities on that vehicle before the vehicle arrives at a service location. Such a process begins by identifying an inbound mobile asset, such as a locomotive 12, and scheduled maintenance data 141 of the asset. The maintenance schedule may be maintained on a computer in the service center 22 or at any other convenient location accessible through the global information network 15 of FIG. 1. Prior to arrival at the shop, a signal is sent to the communication element 112 of FIG. 5, such as an on-board computer, and instructs the element 112 to transmit data on all or at least some monitored parameters 142. The service personnel and service center computer have access to a vast amount of historical and experiential data pertaining to the systems used in various locomotive models, and the personnel and computer can use such data according to an algorithm to determine which maintenance and repair operations are required, advisable, and/or optional 143 for the particular inbound locomotive. A report is generated and sent to the owner of the asset, such as via an Internet web page, to identify such operations while the vehicle is inbound. Decisions 144 are made as to which of the advisable and optional maintenance operations will be performed when the vehicle arrives at the shop. Maintenance personnel may then begin preparations for the repair activities 145 prior to the mobile asset arriving at the repair facility. The system envisions beginning repair operations 146 immediately upon arrival of the asset 12 at the service location 22, obviating the requirement of a time-consuming inspection and decision-making process after arrival in the shop. Information regarding the status of a service activity may also be distributed via the global information network 15. Once a repair is completed and the vehicle is returned to service, performance data may again be monitored 147 to conform a satisfactory completion of the service activity, and information regarding the satisfactory completion may be distributed via the global information network.

The step 143 of determining which operations are recommended may include the analysis process illustrated in FIG. 8. Trends are calculated 126 by comparing values for a given parameter over a period of time and comparing those values with historical data for identical vehicle systems. This enables rapid and accurate correlation of trending data with a dedicated fault occurrence experience database. The trends can be calculated based in part on prior operating data that has been downloaded and collected in the database. The database can be continually updated and may be stored in the memory of the shop computer or off-site at data center 18 where the database may be accessed on-line via the network 15 of FIG. 1.

The systems and methods described herein can enable service personnel to reliably and quickly retrieve a vast amount of archived information directly onto the job floor, either via a kiosk 21 located within the service facility 22 and/or with portable handheld communication and display units 23 that the service personnel can take to the asset (e.g., the vehicle 12). Such data portals 21, 23 may communicate to a central computer via electromagnetic signals, such as RF signals, or on-line via the Internet or via an intranet of the service provider. The data portals advantageously display the information directly at the work site location. Mobile wireless, web-access devices can directly access the intranet of the service provider.

Electronic Service Delivery (E-izing) includes the result of many applications to be utilized at a service application site 22. E-izing involves streamlining and standardizing 20 multiple servicing processes, as well as providing the users with information that the users need to maintain and repair a product on location. A first data portal may be a kiosk 21, e.g., a personal computer (PC)-based information stand that includes technical and safety information currently available in hard copy. Information is made conveniently available at the click of mouse, the touch of a screen, a voice command, 25 etc. A second portal may be a handheld device 23 that could utilize the kiosk 21 as a hub and may be used for displaying real time information relevant to the tasks involved in inspecting and repairing the product 12. The systems and methods described herein may further enable the display of service-related information on a monitoring board to allow service personnel to quickly and accurately know on a real time basis the status of every piece of equipment being serviced at the service site 22 or at other sites. By way of example, the information transmitted through each of these portals 21, 23 may be technical information available in hard copy but enhanced through suitable multimedia applications, such as audio and/or visual drill downs, and/or application wizards that empower the service personnel to make uniformly correct decision across all the service sites.

The electronic data delivery systems and methods described herein allow for improving field service operations by applying e-Business technologies to replace manual paper based processes. The business benefit will include improved availability of the asset by reducing the cycle time of the repairs and to have higher quality repairs. Additionally, other processes, such as inventory management, will be improved to have the correct part available when needed.

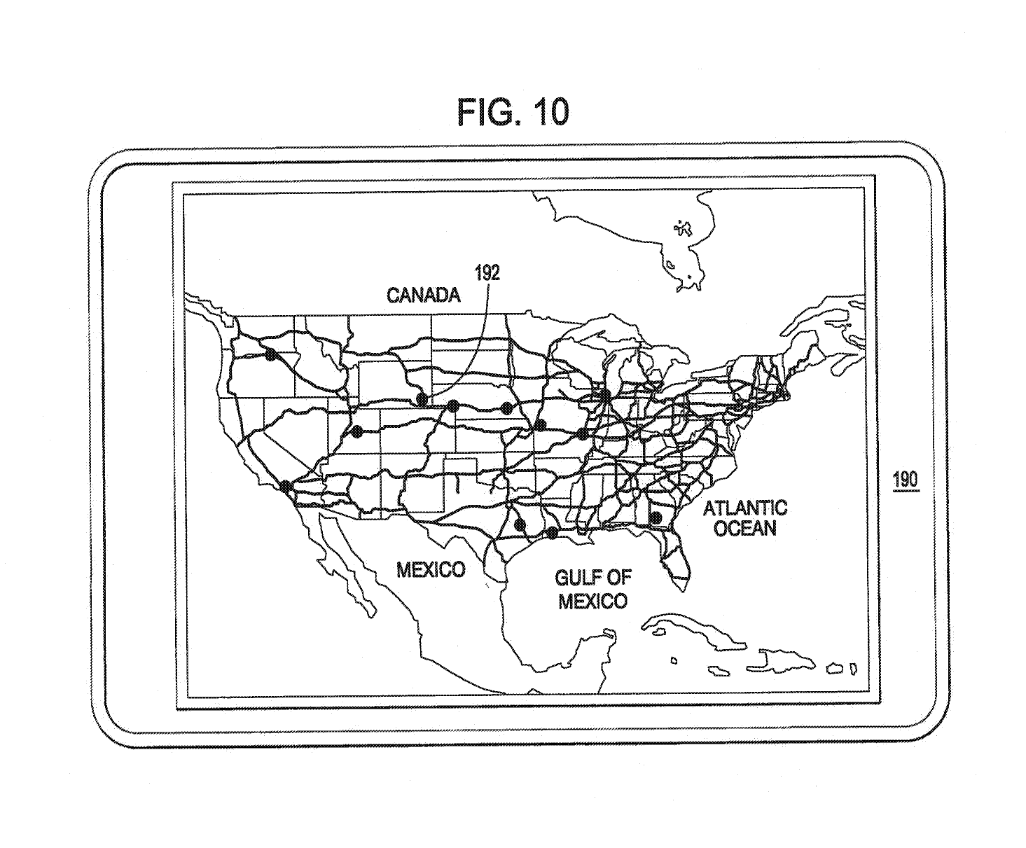

As shown in FIG. 9, a work order flow module 150 can be used to control the various repair processes. One example step or action is to develop an accurate work scope 152 in response to a service recommendation, such as is developed at step 143 of FIG. 8. Information will be electronically accumulated to develop the work scope, and at least part of this information may be communicated via the global information network 15 as illustrated in FIG. 1. By way of example and not of limitation, the information may include the following: performance information from the product 154, repair history information 156, information from the customer 158, required and optional repairs 160, and information learned during inspection 162.

The work scope is used to determine the sequence of repairs 164 based on customer need 158, materials availability 166, and resource availability 168, and drawing upon customized or standard work steps stored in a data warehouse 169. The process will provide service personnel with the information needed to determine the order of repairs and to communicate to the craft workforce.

The execution of the repairs will take place 170 by directing the worker via the data portal 21, 23. The work order 172 provided to the worker via the data portal will direct the worker through each repair that is needed. The completion of each step is recorded via the data portal to update the data warehouse 169 and to provide real-time repair status information via a monitoring board 174. A feedback loop can be used to update the current production configuration. The work order 172 will provide a more controlled and accurate repair process.

The information obtained from the work order completions will allow for monitoring the status of the repairs and will also allow customers 176 to get real-time status of the product in the repair cycle. The data will also be used to improve reliability of the product and to compare and improve field shop processes across field sites. Communication of such information can be efficiently accomplished via the global information network 15 of FIG. 1.

In operation, productivity and performance in a plurality of locomotive fleets can be improved by leveraging advanced communication, diagnostic, scheduling, data handling and locomotive repair technologies, thereby increasing train on time travel and up time. During movement of a vehicle along a route, diagnostic modules can regularly monitor various subsystems of the vehicle to ensure operations stay within set parameters. For example, the onboard system may be configured to maintain optimal fluid conditions to maximize or increase oil life without sacrificing either engine reliability or locomotive performance (e.g., relative to operating the locomotive in a different manner). If the onboard monitor recognizes trends outside predefined limits, the fluids management system highlights the abnormality on the locomotive indicating a potential concern. Based on the severity of the concern, the system may automatically call the remote diagnostics service center with the necessary data to confirm the diagnosis. Expert systems and/or expert personnel evaluate whether a faulty condition is developing outside of the normal boundaries and a corrective action may be proposed and communicated via a global information network. The recommended action may be supplied directly into the train control system. At this time, the data center or service personnel may evaluate the most logical repair location in terms of various criteria, such as train proximity, parts, repair equipment availability, manpower availability, etc. The service recommendation automatically triggers the creation of an electronic work order 172 within a service shop management system. A notification is then sent, such as via an e-mail message or by providing information on an Internet web page, to the service team detailing the parts and labor necessary for a timely and accurate repair.

The recommendation also sets a proximity trigger to notify the service shop when the locomotive is within a certain distance of the repair location. As soon as the service team receives information about the necessary repair, team members gather or reserve the parts, equipment and personnel needed to perform the corrective action 145. The approaching locomotive may automatically forward a notification message to the service repair shop indicating that the locomotive is approaching. Alternatively, the service personnel may utilize a search engine 70 to identify the proximity of locomotives to their respective service shop. An example of a web page presenting such information is shown in FIG. 9. A hyperlink may be provided on this screen to connect the user with nested web pages showing more detailed information regarding a particular locomotive. Upon arrival of the train to the scheduled repair station, the locomotive is repaired by a service technician equipped with the necessary parts and the wireless handheld device 23 that contains the appropriate maintenance, safety and training instructions for the repair to be accomplished safely, quickly and accurately. Furthermore, plans may be made in advance of the train arriving at the service shop for the continued transportation of the cargo being transported by the train, thereby avoiding excessive delays in cargo delivery.

The service technician informs the service shop management system that the operation has been completed. The train continues on the route without delay. During the journey of the train, the technology service center monitors the latest downloaded data 147 to ensure the problem has been corrected.

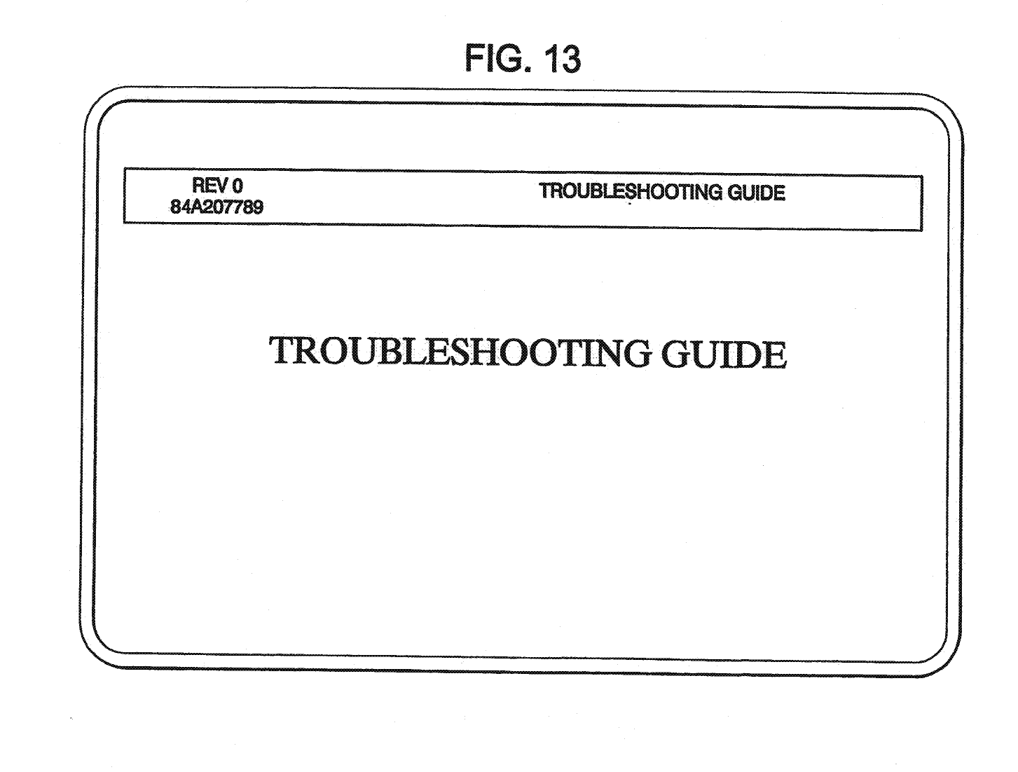

The global information network 15 facilitates the effective communication of many forms of information for improving the management of a plurality of mobile assets, e.g., 12 or 26. A web site accessible through the global information network 15 and using standard Internet Protocol can present information in a variety of formats to satisfy the unique requirements of a variety of users. Such information may include failure predictions, service recommendations, the availability of service shops 22, parts and personnel, the location of a mobile asset or cargo 25 carried by the mobile asset, performance data, audio and video information produced on-board the mobile asset, two-way communication between a mobile asset and a fixed remote location 14, 18, 22, 24, statistical information regarding the availability of the assets, repair status information, etc. Not all embodiments described herein are limited to fixed remote locations since, in some instances, some aspects of the management of the fleet could be conducted from a mobile asset, such as a mobile data management trailer and the like. Web site technology, including interconnected web pages and hyperlink connectivity, may be used to present multi-media information. Example web pages from a web site created as part of the system 10 of FIG. 1 are illustrated in FIGS. 12-14.

FIG. 12 illustrates an example web page 200 providing hyperlinks to a variety of design documents for a locomotive. One such hyperlink 202 takes the user to an interconnected page having a specific troubleshooting guide. That page is illustrated in FIG. 13. Web page 200 also includes the capability for the user to conduct a search, such as by inputting a specific vehicle number 204. FIG. 14 illustrates another web page 210 where best practices are shared by the posting of messages by various users. Here, again, various search capabilities are provided 212 to enable the user to use the information effectively, and various hyperlinks 214 provide easy connections to other associated web pages and functions. As bandwidth capabilities increase and become less expensive, the benefits of the systems and methods described herein will become even more beneficial.

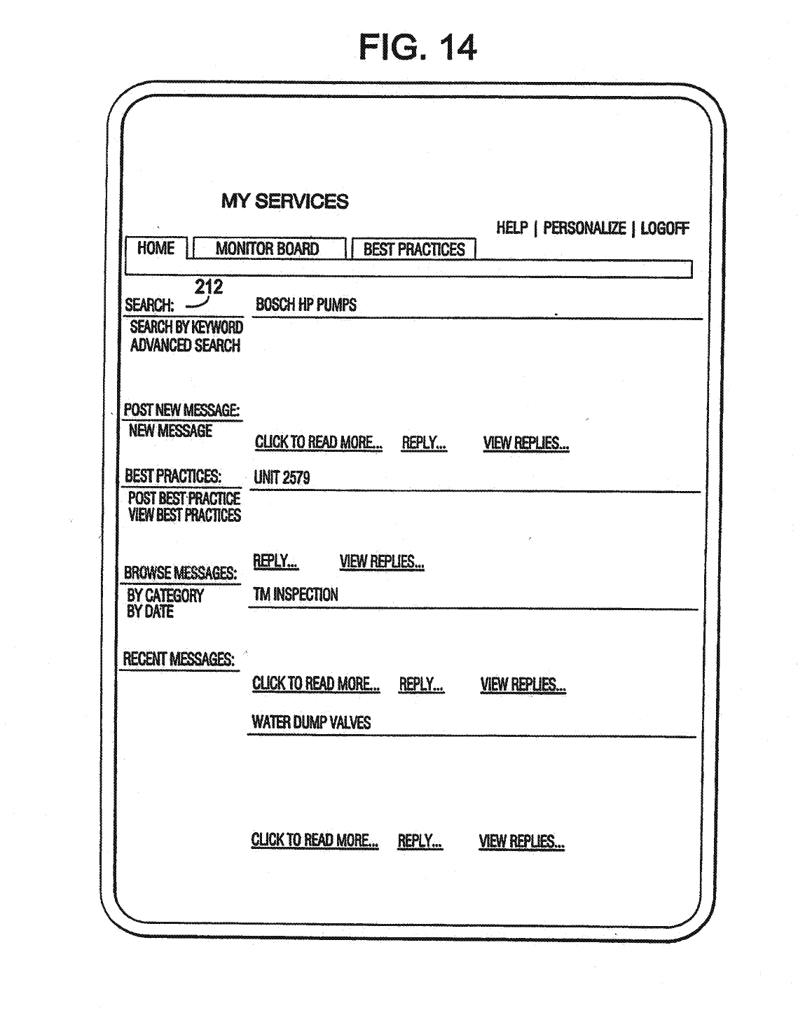

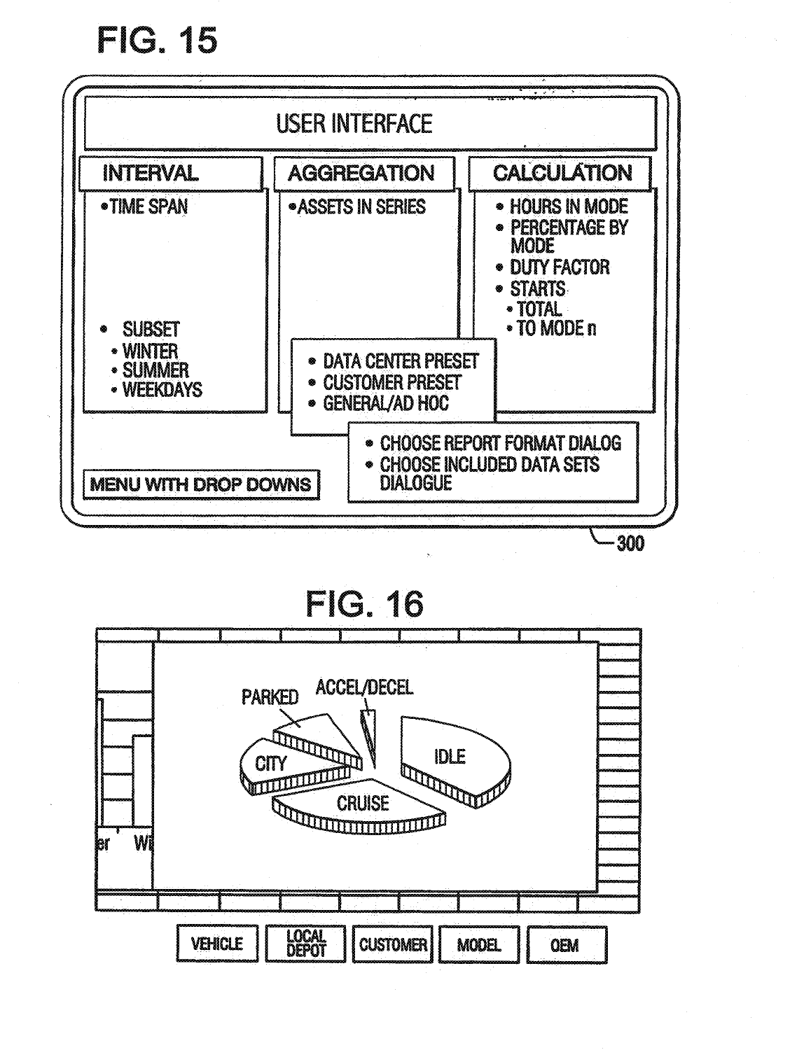

FIG. 15 shows an example web page that may be used for meeting a contractual obligation to report out on usage, e.g., seasonal usage, of a fleet of mobile assets. The user logs into a profiler web site with an appropriately authorized password and identification code. The graphical user interface (GUI) is configurable to flexibly allow for making various comparisons of actual usage of the fleet of mobile assets. For example, the comparisons may be default comparisons set by the data center, or may be based on comparison requests set by the user and may accommodate general or ad hoc comparison requests. The user may choose from an interval menu 20 to choose the time span to be displayed, e.g., fleet data based on last year usage for a given site, or the time span may comprise the last ten years of fleet data. If desired, the user may select from an interval subset menu and select various comparisons, e.g., seasonal comparisons, summer, winter, fall, spring, or other criteria, such as weekdays, weekends. The user may also choose from an aggregation 25 menu to choose multiple comparisons as a function of mobile asset number, or fleet number or any other criteria helpful to that user. For example, the user may be authorized to monitor only a fleet under her managerial responsibility but may not be authorized to monitor fleets operated by other fleet managers. The user may also select calculation of a duty factor that may be defined as percentage of available output made during the interval. Upon completion of the selections, the profiler web site generates a plot and/or report, as customized by the user. FIG. 16 illustrates an example pie chart plot that indicates the amount of time a given set of mobile assets may have spent in respective operational modes, such as city driving, highway driving, idling, parked, cruising, accelerating, decelerating, loaded, unloaded, braking, hot weather, cold weather, etc.

Below are listed various example embodiments that may be particularly suitable for on-road vehicles, such a fleet of trucks, autobuses, taxi cabs, etc. In one embodiment, the system includes a display device configured to display a routing for the driver that identifies which locations to stop at for “refueling” of the vehicle. The routing would identify the respective locations applicable to the route being driven by the driver for a given opportunity. The refueling could simply involve those locations which have a competitive contract price per gallon for fuel.

In another embodiment, the system can include a diagnostics routine that would help prevent air brake inspection failures. Air brake inspection failures are believed to be the leading source of Department of Transportation (DOT) fines involving commercial vehicles. Thus, this routine would indicate the wearing of disc pads and linings. By using standard sensor devices, the routine would also provide information on the air pressure level in the airlines and air-compressing equipment. The route would also indicate when the brake cable is no longer functioning.

In still another embodiment, incentives or awards, conceptually analogous to “Frequent Filler Miles,” may be issued to the drivers to entice such drivers to come to preferred service stations and give them frequent filler miles toward personal vacations, awards (discounted airline tickets, hotel, etc.). The service station would be equipped with a suitable wireless data transfer device so that when the truck pulls up to the pump station, the diagnostic information would be uploaded to the central computer. It is contemplated that the truck tires may be positioned to rest on an optical tire-wear reader which records tire wear and inflation. In case of inadequate inflation and/or excessive tire wear, the diagnostic routine would provide in real time corrective actions to the operator and possibly avoid a road failure. It is further contemplated that the truck may be fitted with a quick oil connection which allows flow of oil to suitable oil viscosity and quality measuring devices, before the operator shuts off the engine. Similarly, information about idle performance may be recorded while the truck is being refueled.

It will be appreciated that the system and techniques of the inventive subject matter can allow for enhanced “On-Time” delivery service. This service is now achievable by accurately determining and coordinating GPS-based locations for truck and rail interactions to improve load and/or driver hand-offs and schedules, especially when there may have been some delays due to force majeure events.

The system and techniques described herein may allow the OEM to issue extended warranties for the mobile assets. For example, assuming the operator of the asset is in compliance with the condition-based service and monitoring and diagnostics services, the warranty period may be extended to, for example, up to three times the standard mile coverage. Further, the users of the vehicle may now have the ability to operate their vehicle in previously non-attainable zones because of the enhanced operational characteristics derived from having clean air filters, oil with proper lubricity, well-tuned engine, etc., due to the condition-driven maintenance. In some sport utility vehicles, a 35% improvement in fuel consumption may be achieved as a result of such condition-driven maintenance. Vehicular leasing companies may greatly benefit from the various aspects of the inventive subject matter as well for similar reasons.

The system may further include hardware and software configured to provide profile-driven marketing to users of the vehicles. Such marketing may take advantage of smart private-label credit or debit cards as an example medium to store coupons, incentives and other marketing benefits. Tracking of utilization of the vehicle and utilization of the related credit card and generated bonus “gifts” incentives and discounts either in conjunction with using fleet purchasing agreements or simply taking advantage of private advertising which may produce direct revenue for the respective business entities that operate the respective fleets of mobile assets.

Examples of such profile-driven incentives may be as follows: A map appears at the time of night when a given driver usually eats dinner. The map may provide directions to a restaurant near the fleet fuel depot where that driver can get a free dessert with her dinner purchase. Utilization of the coupon results in a transaction fee to the entity. Fueling at the depot results in a bonus to the entity. Data is collected to better target the incentives. For example, the data center may have been previously informed that a given driver is member of the American Automobile Association (AAA) and the data center may automatically deliver to that driver a list of AAA discount hotels when that driver is on route to visit grandma. As suggested above, in one aspect of the inventive subject matter, the actual mobile asset usage history may be based on a plurality of measured and or calculated parameters. Table 3 below provides an example list of such parameters.

TABLE 3
Actual Mobile Asset Usage History

Measured Parameters
Starts-(e.g., Norma., Cold, Hot, Stalls)
Hours-(e.g., City, Idle, Highway, High Load)
Load Cycles-(e.g., Day, Night, Weekend)
Speed-(e.g., Engine, Vehicle)
Braking-(e.g., Number of Times, Force)
Environment-(e.g., Temperature, Barometer,
Location, Elevation, Weather
Climbing/Downhill)
Engine Parameters-(e.g., Temperature,
Oil Pressure, Voltage/Amperage)
Fault Logs
Mileage-(e.g., Trip, Total)
Calculated Parameters
Acceleration
Deceleration/Braking Level
Instantaneous/Cumulative Fuel Use
(e.g., Per Hour, Per Driver, Per Mile)

In another aspect of the inventive subject matter, trending history may be used for estimating the time before a road failure occurs. Table 4 below lists exemplary criteria that may be used for using the trending history of the mobile asset.

TABLE 4
Trending/History
Trend measured and derived values to predict faults
Time under load-(e.g., Low, Medium, High Load)
Time used when not properly maintained
Time used when condition-based maintenance is used

In another aspect of the inventive subject matter, the maintenance history of each mobile asset as listed in Table 5 is reliably and quickly made available to authorized remote users for a multiplicity of uses as exemplarily listed in Table 6 below.

TABLE 6
Exemplary Maintenance/Service History
Fuel
Oil Change/Filters
Repair, e.g., brake repair, engine repair
Diagnostics for Faults/Repairs
Prognostics for Anticipated Faults

TABLE 6
Exemplary Uses of Information
Insurance
Identity Bad Actors/Repeat Offender
or Repairs/Maintenance
Asset management
Resale of asset
Maintenance planning
DOT compliance
Condition-based maintenance
Asset history to evaluate
needed repairs
Ordering parts and components
for repairs
Tracking of vehicles and freight
Service contracts performance
Warranty claims
Leasing contracts
Better knowledge of Lease
Residual Value

In another aspect of the inventive subject matter, various data may be timely and reliably communication to distinct users generally remote from one another to greatly facilitate management of a fleet of remote assets. Table 7 below provides various example actions that are greatly facilitated by the inventive subject matter described herein.

TABLE 7
Remote monitoring
Asset Management
Instructions for Repair
(Nearest recommended repair/facility)
Remote Lock/Unlock/Prevention of Starting
Text, video and audio to driver

In yet another aspect of the inventive subject matter, onboard processing of data may be conducted to facilitate communication of data from the mobile asset to the data center. Examples of such on-board data processing are illustrated in Table 8 below.

TABLE 8
On-Board Data Reduction
(Calculations/Trends/Fault Reporting/
Selective Data/Request only data, Vehicle
Set Points (Speed Governors)

As suggested above, condition-based dynamic maintenance planning and the utilization of such dynamic maintenance planning allows for better assessing the residual value of the mobile asset. In general, such condition-based maintenance planning allows for establishing a cost/benefit evaluation of the mobile asset for a proposed future plan of use in light of the state of health of the mobile asset. For example, assuming the mobile asset is leased, then at the time of expiration of the lease, it would be useful to the OEM to know for each mobile asset how that individual asset was operated and maintained. If the asset was appropriately maintained, even though the asset was heavily used, then the residual value of that asset may be comparable or higher than the residual value of another asset with more moderate use but lacking a fully compliant maintenance program. Another potential aspect would be the utilization of such dynamic maintenance plan to manage aggregate purchase agreements. For example, automatically instructing the driver to have the mobile asset serviced at a particular preferred service shop, part of a chain of service shops, with which the fleet operator has previously negotiated preferred discount rates.

Mobile Assets Information Services

In another aspect of the inventive subject matter, the fleet data management tools of allow for providing enhanced services in connection with the fleet of remote assets by:
Enhancing residual value of the asset by retrofitting data collection and processing devices to provide various data management services
Enhance initial value of the asset by inclusion of such devices as original equipment

As suggested above, such data management services may include some or all of the 10 following services:

1. Electronic and remote hosting of computer-readable maintenance records in support of compliance with governmental agencies, e.g., Department of Transportation (DOT), condition based maintenance planning, historical asset utilization.

2. Usage profiling, such as may be provided by accurately determining actual usage of any individual asset, e.g., monitoring, as a function of time, available control system data such as tachometer, odometer, fuel flow, and/or environmental parameters such as temperature, altitude, humidity, etc. The usage profiling may be performed in conjunction with host data archival services used in support of various processes encountered during the operation of the fleet of assets, such as fleet maintenance scheduling, engine optimization for fuel efficiency, compliance of driver sleep and/or speed requirements, logistics planning and may include information from terrain and/or weather maps where the vehicle has traveled.

3. Value added services based on some or all of the preceding stored knowledge, with or without the assistance of processing or expert systems that may be developed in conjunction with the gathering of historical performance data to establish data-driven signatures or triggers for maintenance escalation.

4. Such systems may include:
Storing onboard and/or off board engine or other subsystem related models 30;
Trending of measured and derived parameters and comparison to expected values to indicate anomalous conditions;
Exceeding dynamically calculated maintenance intervals for use in operational changes;
Scheduling maintenance and/or pre-ordering needed parts for remediation and improvement; and/or
Maintenance plans optimized for the fleet as opposed to just a single vehicle.

5. Non-maintenance related information services may include some or all of the following:
Use of position and usage information in support of logistics both track and trace and match load requirements;
Interaction with aggregate purchase agreements to direct equipment operators to outlets for the covered material; and/or
Virtual real time data messaging to/from driver.

6. Basic remote control of remote assets via secure communication such as
Locking or unlocking of access doors/windows; and/or
Preventing vehicle start.

7. It is contemplated that such services could be provided as stand-alone service contracts in association with purchase of enabling retrofit of already deployed assets or in connection with deployment of new models. Alternatively, such services could be provided as part of contract service agreements or in conjunction with delivery of performance guarantees and full scope leasing arrangements. In one embodiment, the assignee of the present application may advantageously leverage domain knowledge created through GE Fleet Services or in connection with commercially available leasing services, e.g., Penske Truck leasing, to create a business process to be electronically-enabled for application in private fleet garages.

In operation, the system and techniques of the inventive subject matter can provide the following:

1. A combination of devices performing data concentration, data communications, data reduction, data processing, archival and marketing to provide the following:
Data acquisition onboard of mobile assets to gather, store and preprocess data from the electronic control systems, additional sensors (GPS, ambient conditions and others), and accessory subsystems such as “cherry pickers” or drilling rigs;
Such system to be remotely upgradable in software and/or diagnostic algorithm tuning parameters;
Such system to support modifications of controls set points such as governor settings based on central or distributed decision making by experts or by the system;
Such data processing configured to identify anomalous conditions that may require escalation and communication either through annunciation in the cab, remote real time communications or periodic data dumps at properly designated way points;
Communications capabilities with on board real time system using GPS, cell phones, satellite-based communications, etc.;
Radio Frequency (BY) (both long and short range), Infrared (IR) for wireless communications at way points (during fueling for example);
Wired functionality at service shops;
Remote data center or centers aggregating data, processed data, fleet information, dynamically revised models and anomaly triggers, off board expert systems; and/or
To create operations and maintenance action recommendations to be communicated through, phone, pager, e-mail or other feedback systems including direct interaction with the data concentrator or communications modules of the data concentrator.

2. The system and techniques of the inventive subject matter can provide more timely and cost effective services for managing a fleet of remote assets, including leasing of a fleet of mobile assets by providing the following:
Improved driver satisfaction and compliance of maintenance of the asset which directly improves the residual value of the asset; and/or
More robust aggregate purchase agreements because timely delivery of fleet-related data allows for more effective use of such purchase agreements, new services such as freight or mobile asset tracking and utilization advice, broader reach to non-GE service shops through sharing of advantageous GE business practices offering of performance guarantees based on estimated cost of operation per mile including cost of fuel and tires.

Additional embodiments of the inventive subject matter described herein relate to methods and systems for indicating a repair to perform on an asset based on historic data related to a repair on the asset and/or sensor data associated with the asset. An evaluate component aggregates information related an asset such as a repair performed or data from a sensor. A repair evaluation component indicates a repair to perform on the asset based on at least one of the data from the sensor or the information related to the asset. By utilizing asset-specific information and historical data, repair schedules for assets can be more accurate and thereby reducing untimely repairs.

The term “component” as used herein can be defined as a portion of hardware, a portion of software, or a combination thereof. “Hardware” refers to electronic circuits/circuitry, logic circuits/circuitry, and/or one or more processing elements (e.g., microprocessors or controllers) that is configured for the carrying out of one or more functions and/or methods (e.g., functions and/or methods as set forth herein), through execution of associated software (stored in a non-transitory electronic-readable medium, which may be part of the hardware), through the arrangement of the circuits/circuitry, and/or otherwise. “Software” refers to instructions that are readable and/or executable by hardware, stored in non-transitory electronic-readable media, which cause the hardware to perform designated functions, designated actions, and/or behave in a desired manner. “Non-transitory electronic-readable media” include, but are not limited to, non-volatile RAM, ROM, PROM, etc., a CD-ROM, a removable flash memory card, a hard disk drive, a magnetic tape, a floppy disk, and/or combinations thereof. The term “client asset” or “asset” as used herein means a fixed asset or a mobile asset that is owned and/or operated by a client entity such as, for example, a railroad, a power generation company, a shipping company (e.g., land, sea, air, and/or an combination thereof), a mining equipment company, an airline, or another asset-owning and/or asset-operating entity. The term “vehicle” as used herein can be defined as an asset that is a mobile machine or a moveable transportation asset that transports at least one of a person, people, or a cargo. For instance, a vehicle can be, but is not limited to being, a rail car, an intermodal container, a locomotive, a marine vessel, mining equipment, a stationary power generation equipment, industrial equipment, construction equipment, and the like. The term “repair facility” as used herein can be defined as a location that evaluates and/or performs a repair on a vehicle or other client asset. The term “Car Repair Billing” (CRB) as used herein can be defined as a computer-implemented system with a portion of software, a portion of hardware, or a combination thereof that facilitates reporting and/or auditing railroads, car owners, client asset owners, vehicle owners, lessee, lessor, among others. CRB includes Association of American Railroads (AAR) administered as well as contract billing, and another suitable billing for railroads.

The term “Maintenance Management System” (MMS) as used herein can be defined as a computer-implemented system with a portion of software, a portion of hardware, or a combination thereof that facilitates analyzing repairs for a vehicle and/or auditing repairs for a vehicle to railroads, car owners, client asset owners, vehicle owners, lessee, lessor, among others. The MMS can receive repair information from a repair facility. The vehicle owner can use MMS to input repair data received from repair facility and then views, audits, pays, etc. based on the data received. The term “part” as used herein can be defined as a portion of a client asset and/or a portion of a vehicle, wherein the “part” is involved in a repair for at least one of the client asset or the vehicle. The term “ownership” as used herein can be defined as proof of legal claim to property such as a vehicle. The proof can be a title, a lease agreement, a contract, a legal document, a purchase agreement, among others. The term “repair” as used herein can be defined as a service on a vehicle, wherein the service can be a repair of a part, a replacement of a part, a maintenance of a part, a repair of a portion of the vehicle, a replacement of a portion of the vehicle, a maintenance of a portion of the vehicle, and the like. The term “substantially similar” as used herein can be defined as exactly the same, similar to one another in that more than half of one element is the same as another element. In another embodiment, “substantially similar” a first element can be 75% the same as a second element.

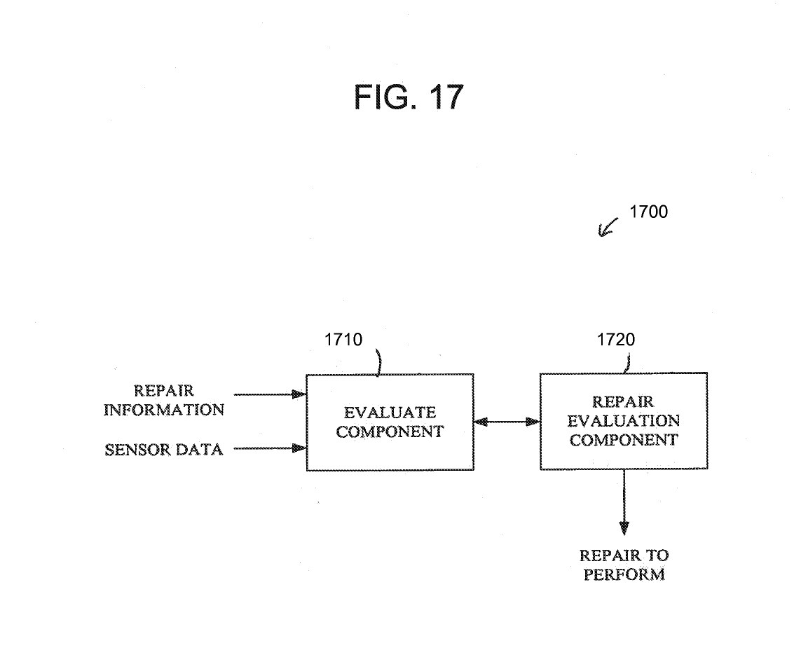

FIG. 17 is an illustration of a system 1700 for ascertaining a repair to perform on an asset based on at least one of repair information (e.g., also referred to as a portion of historic data) or sensor data (also referred to as a portion of sensor data). The system 1700 includes an evaluate component 1710 that can be configured to aggregate (e.g., collect, retrieve, request and receive, among others) or receive at least one of a repair information or sensor data related to an asset. Repair information utilized by the system can include a portion of historic data related to an asset or a repair on the asset (described below). The system can include a repair evaluation component 1720 can be configured to indicate a repair to perform on the asset based at least in part upon the repair information or the sensor data. By way of example and not limitation, the repair to perform on the asset can be performed at a later point in time in comparison to a repair the repair data is associated with (e.g., the repair information evaluated, the sensor data evaluated, among others). In an embodiment, the repair evaluation component can generate an indicator for a repair on an asset, wherein the indicator is based at least in part upon the portion of historic data related to the repair on the asset or the portion of sensor data related to the asset.

In one embodiment, an asset can include a repair such as an oil change in which a manufacturer suggested indicator can be a first mileage. A manufacturer suggested indicator can be a recommendation or instruction to repair, inspect, replace, or take some other action in connection with an asset in response to a designated event or time occurring that is provided by the manufacturer of the asset. The asset can include a user-defined indicator to perform the oil change such as a second mileage. Yet, based on the evaluation of historic data related to the asset and/or the repair, and/or a portion of sensor data (e.g., oil integrity sensor, oil samples collected, among others), an indicator of a third mileage can be implemented in order to ascertain a repair to perform on the asset and a time or date to perform the repair. By evaluating each asset performance and conditions of use (e.g., discussed more below), a repair to perform can be indicated and an appropriate frequency to implement such repair can be used (e.g., utilizing a created indicator that includes a time or date to perform a repair on an asset).

The repair evaluation component can be configured to calculate a date or time associated with the indicated repair. For instance, the date or time can be a projected deadline in which the indicated repair should be performed in order to mitigate damage (e.g., part failure, asset failure, degradation of asset performance, increase risk of damage, among others) for the asset. The projected date or time can be based on the portion of historic data or the portion of sensor data in which an indicator can be created (referenced above).

The evaluate component can be a stand-alone component (as depicted), incorporated into the repair evaluation component, or a combination thereof. The repair evaluation component can be a stand-alone component (as depicted), incorporated into the evaluate component, or a combination thereof. Moreover, the system can be implemented within or part of at least one of a Software as a Service (SaaS), cloud-computing environment, a network environment, a local network, a remote network environment, or the Internet.

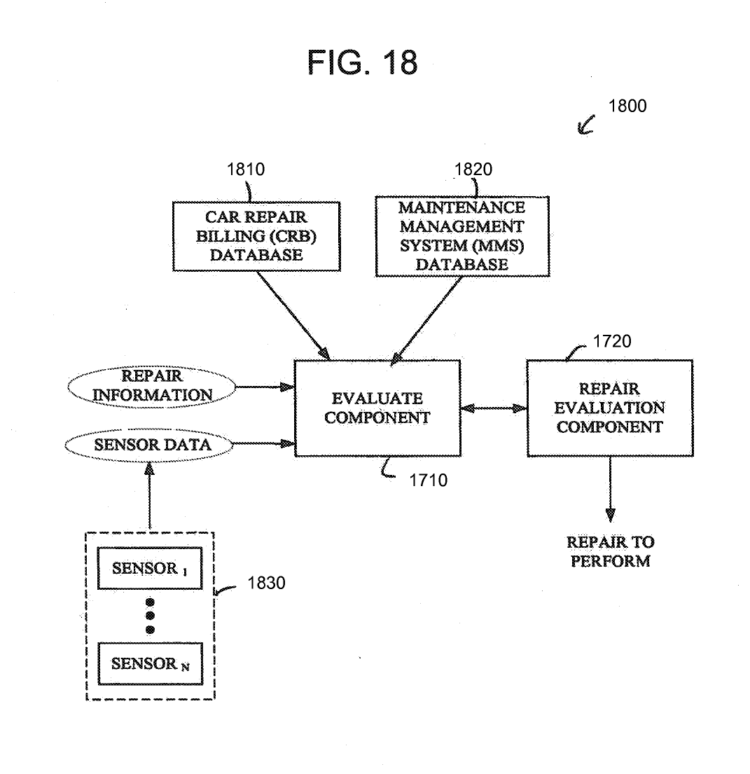

FIG. 18 is an illustration of a system 1800 for utilizing historic data related to a repair on an asset and sensor data for the asset to indicate a repair to perform on the asset at a particular date or time. The system includes the evaluate component that utilizes at least one of repair information (e.g., also referred to as a portion of historic data related to a repair performed on an asset) or sensor data (e.g., also referred to as a portion of sensor data related to the asset). The repair evaluation component leverages the portion of historic data and/or the portion of sensor data (via the evaluate component) to indicate a repair to perform (e.g., in a future point in time) on at least one asset.

By way of example and not limitation, repair information can be a previous repair on an asset, a part used in a repair on an asset, a date or time a repair was performed on an asset, a manufacturer suggested indicator to perform a repair on an asset, a user-defined indicator to perform a repair on an asset, a repair facility that performed the repair on the asset, repair details (e.g., who performed repair, issues related to performing the repair, duration of time to complete repair, downtime for the asset that received the repair, among others), financial information related to the repair (e.g., cost of repair, cost of part(s) for repair, among others), asset information (e.g., type of asset, use of asset, cargo load of asset, location of asset, conditions of use for asset, owner of asset, pricing contract for repairs to the asset, among others), data related to Maintenance Management System (MMS), data related to Car Repair Billing (CRB), and the like.

For instance, a repair can be previously performed on an asset ten (10) times in the past year, wherein the historic data (e.g., data related to the repair performed on the asset for those ten times) and/or sensor data (e.g., data collected related to the part(s) or portions of the asset affected by the repair, can be evaluated. Based on such evaluation, a projected estimate in time (e.g., also referred to as an indicator) for a repair (e.g., the same repair, a similar repair, a repair including one or more similar part(s), among others) to be performed can be indicated by the repair evaluation component.

The system can be utilized with a suitable Car Repair Billing (CRB), a CRB database 1810, Maintenance Management System (MMS), and/or a MMS database 1820, as well as an environment (e.g., user, repair shop, company, entity, corporation, among others) that employs CRB and/or MMS. For instance, the CRB database and/or the MMS database can be utilized by the evaluate component 1710 in order to ascertain at least one of a history of repair(s), repairs performed, manufacturer suggested indicator, user-defined indicator, duration of repair, frequency of repair, part(s) used for a repair on an asset, cost of a repair, brand specific life expectancy, part life expectancy, among others.

The system can include one or more sensors 1830, such as, for instance, sensor 1 to sensor N, where N is a positive integer. The sensors can collect information from an asset in real-time, statically, or stored and subsequently accessed (e.g., collected). In an embodiment, the sensors can be a detector that utilizes real-time data collection or detection, wherein the detection is related to an asset. (Thus, a real time sensor is one that outputs sensor data substantially concurrently with what is being sensed, and/or that outputs data sufficiently rapidly for the system to control the source of the data. “Substantially concurrently” means but for delays due to electronic operation of the sensor, e.g., 1700 msec or less.)

By way of example and not limitation, a portion of sensor data can be information received or collected from at least one of a wheel input, a load detector, a hot bearing detector, a dragging equipment, a real time sensor, a wheel degrade sensor, a flat spot detector, or an equipment health data sensor, among others. Still, an asset sensor or asset detector may be chosen with sound engineering judgment without departing from the intended scope of coverage of the embodiments of the inventive subject matter. The sensors can collect information that can be evaluated in order to identify at least one of a repair to perform, a degradation of a part, a condition of an asset, a condition of a part, a condition of a repair, among others.

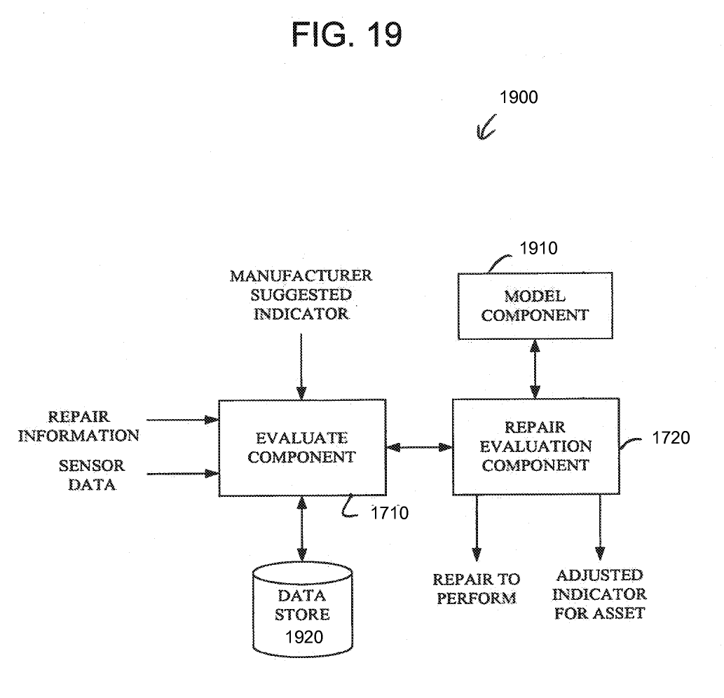

FIG. 19 is an illustration of a system 1900 for creating an indicator for an asset which determines timing for a repair to perform on at least the asset or an additional asset. The evaluate component can aggregate data related to an asset via at least one of repair information (e.g., historic data related to a repair performed on the asset, among others) or sensor data (e.g., data related to an asset or a part in which such data is collected by a sensor or detector). Based on such evaluation, the repair evaluation component can indicate a repair to perform on the asset or an additional asset.

The repair evaluation component can be configured to ascertain an indicator for a repair to perform based on the portion of historic data or the portion of sensor data, wherein the indicator relates to at least one of the asset or a part associated with the indicated repair to perform. An indicator can be used by the repair evaluation component to indicate a repair to perform on an asset. In an embodiment, the evaluate component can receive or collect a user-defined indicator (e.g., user-defined indicator to perform a repair on an asset). In another embodiment, the evaluate component can receive or collect a manufacturer suggested indicator (e.g., manufacturer of a part or an asset that defines an indicator for a repair to perform on said part or said asset).

By way of example and not limitation, the indicator can be a duration of use, a duration of time, a measurement of distance traveled for the asset, or a failure rate. The indicator created by the repair evaluation component (e.g., based on repair information and/or sensor data) can be utilized to notify and/or trigger a performance of a repair on two or more assets. In an embodiment, the repair evaluation component can adjust a manufacturer suggested indicator related to performance of a repair based on at least one of the portion of historic data or the portion of sensor data. In an embodiment, the repair evaluation component can modify at least one of a user-defined indicator for a repair on an asset, a manufacturer suggested indicator for the repair on the asset, or a combination thereof based on at least one of the portion of historic data or the portion of sensor data.

The system can include a model component 1910 that can be configured to generate a repair-to-perform model for an additional asset based on at least one of a collection of data (e.g., portion of historic data, portion of sensor data, among others) for a first asset. The repair-to-perform model can be generated from a first asset and used for an additional asset based on a relationship (discussed below). For instance, the repair evaluation component can indicate a repair to perform on a first asset based on collected information associated with the first asset. The model component can create a repair-to-perform model for an additional asset based on the indicated repair(s) for the first asset. Thus, the indicated repair(s) for each asset can be leveraged to be used for additional assets based on various factors, conditions, or definitions. This relationship between an asset (e.g., the first asset) and an additional asset can extend the use and predictability for identifying repairs for assets.

In an embodiment, a repair can be indicated for an additional asset based on a relationship with an asset, wherein the repair evaluation component has indicated a repair to perform on the asset and the relationship between the additional asset and the asset is to have a substantially similar condition of use. By way of example and not limitation, the condition of use can be associated with a location of the asset, a weather condition for a location of the asset, a cargo load related to the asset, a duration of time the asset is used, among others. In an embodiment, the relationship can be a substantially similar asset type between the additional asset and the asset (e.g., type, model, make, brand, year, function, among others). For instance, a generic asset and a name brand asset can be utilized as relationship in which one is used to model the other and repair(s) are indicated for both the generic asset and the name bran asset (or a combination thereof).

In an embodiment, the additional asset can be comparable or substantially similar to the first asset (e.g., first vehicle of brand A and model B and a second vehicle of brand A and model B, first vehicle of brand A and model B and a first vehicle of brand A and model C, among others). In another embodiment, the additional asset can be used in a similar or comparable environment of the first asset (e.g., first asset used in location A and additional asset used in location A, first asset used in location A and additional asset used in location B, where A and B are similar or comparable, and the like). In an embodiment, the additional asset can include a similar condition of use with the first asset.

In an embodiment, the evaluate component, the model component, and/or the repair evaluation component or other discussed components or elements (e.g., CRB database, MMS database, cost component, among others) stores information related to the systems 1700, 1800, 1900, and/or 2000 with a data store 1920. The data store can include information such as, but not limited to, asset information, repair information, sensor data, detector information, repair information, conditions of use for assets, repair history data, among others, and/or a suitable combination thereof.

It is to be appreciated that the data store can be, for example, either volatile memory or nonvolatile memory, or can include both volatile and nonvolatile memory. The data store of the subject systems and methods is intended to comprise, without being limited to, these and other suitable types of memory. In addition, it is to be appreciated that the data store can be a server, a database, a hard drive, a flash drive, an external hard drive, a portable hard drive, a cloud-based storage, and the like.

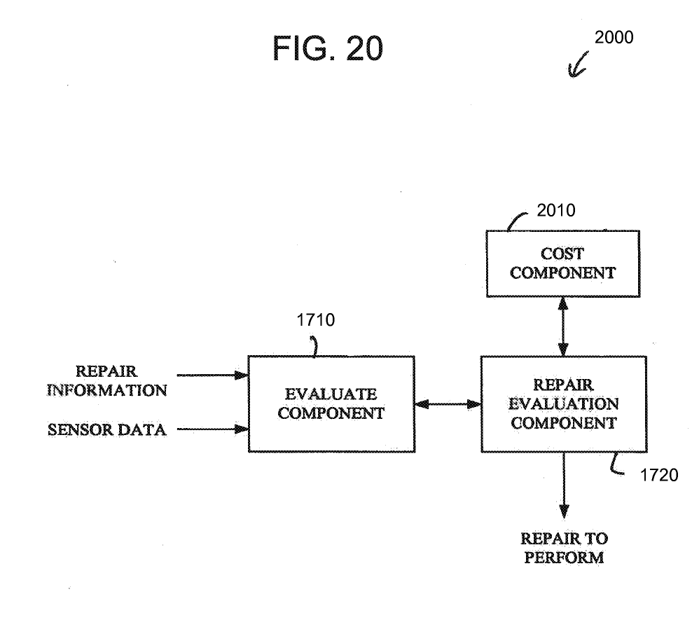

FIG. 20 is an illustration of a system 2000 for ascertaining a cost associated with a repair to perform on an asset. The system can include a cost component 2010 that can be configured to evaluate a cost of a repair indicated by the repair evaluation component. The cost component can provide real time estimates for pricing of parts and/or repair(s) for a vehicle. For instance, upon indication of a repair to perform, the cost component can retrieve pricing information based on, but not limited to, historic data related to the repair performed in the past, pricing information from a repair facility, contract billing information between a repair and a repair facility, among others. In an embodiment, the cost component can evaluate historic pricing information for at least one of a part, a repair, a repair facility, a type of repair at a repair facility, among others. Although depicted as a stand-alone component, the cost component can be incorporated into the evaluate component, incorporated into the repair evaluation component, or a combination thereof.

In an embodiment, a system is provided that includes at least the following: means for evaluating a portion of sensor data related to an asset (e.g., system 1700, component, controller, evaluate component, among others); means for evaluating a portion of historic data associated with a repair to the asset (e.g., system 1700, component, controller, evaluate component, among others); and means for indicating a repair to perform on the asset based on at least one of the portion of sensor data or the portion of historic data (e.g., system 1700, component, controller, repair evaluation component, among others).

The aforementioned systems, components, (e.g., evaluate component, repair evaluation component, among others), and the like have been described with respect to interaction between several components and/or elements. It should be appreciated that such devices and elements can include those elements or sub-elements specified therein, some of the specified elements or sub-elements, and/or additional elements. Further yet, one or more elements and/or sub-elements may be combined into a single component to provide aggregate functionality. The elements may also interact with one or more other elements not specifically described herein.

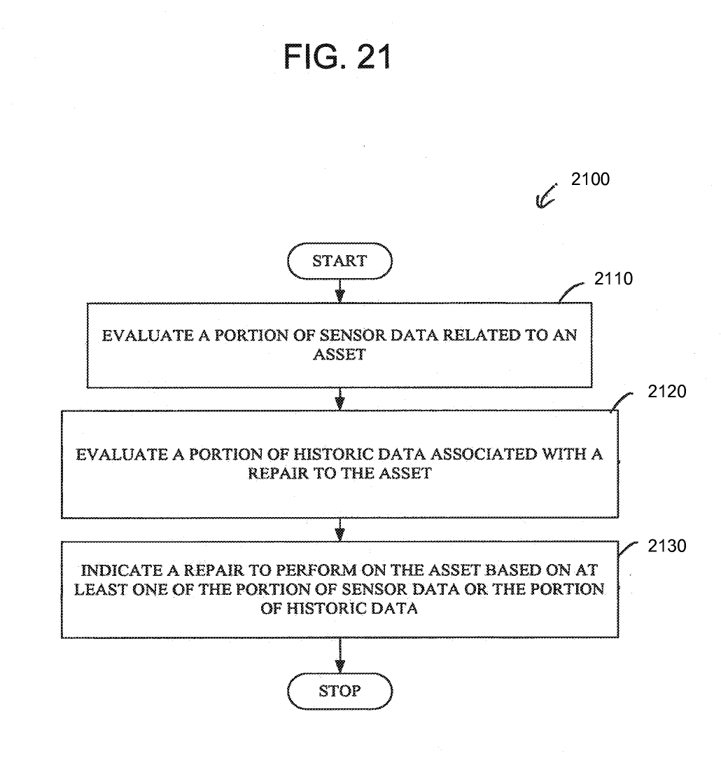

In view of the example devices and elements described supra, methodologies that may be implemented in accordance with the disclosed subject matter will be better appreciated with reference to the flow chart of FIG. 21. The methodologies are shown and described as a series of blocks, the claimed subject matter is not limited by the order of the blocks, as some blocks may occur in different orders and/or concurrently with other blocks from what is depicted and described herein. Moreover, not all illustrated blocks may be required to implement the methods described hereinafter. The methodologies can be implemented by a component or a portion of a component that includes at least one or more processors, a memory, and an instruction stored on the memory for the processor to execute.

FIG. 21 illustrates a flow chart of a method 500 for identifying a repair to perform on an asset. At reference numeral 2110, a portion of sensor data related to an asset can be evaluated. At reference numeral 2120, a portion of historic data associated with a repair to the asset can be evaluated. At reference numeral 2130, a repair to perform on the asset can be indicated based on at least one of the portion of sensor data or the portion of historic data.

The method can further include identifying at least one of a date or a time to perform the repair on the asset. The method can further include generating an estimated cost for the indicated repair based on at least one of the portion of sensor data or the portion of historic data. The method can further include receiving the portion of historic data from a Maintenance Management System (MMS) database. The method can further include receiving the portion of historic data from a Car Repair Billing (CRB) database. The method can further include collecting the portion of sensor data for the asset from at least one of a wheel input, a load detector, a hot bearing detector, a dragging equipment, a real time sensor, a wheel degrade sensor, a flat spot detector, or an equipment health data sensor. The method can further include collecting conditions of use data related to the asset. The method can further include the conditions of use data are associated with a location of the asset, a weather condition for a location of the asset, a cargo load related to the asset, or a duration of time the asset is used.

The method can further include modeling a schedule for a repair for an additional asset based on at least one of the portion of the sensor data or the portion of historic data. The method can further include the additional asset to include a substantially similar condition of use data of the asset. The method can further include communicating information including at least one of an asset identification, the indicated repair, an estimated time of the repair, a part associated with the repair, and a cost of the repair. The method can further include adjusting a manufacturer suggested indicator to perform a repair based on at least one of the portion of sensor data or the portion of historic data. The method can further include generating an indicator to perform the indicated repair on the asset, the indicator relates to at least one of the asset or a part associated with the indicated repair. The method can further include the indicator being at least one of a duration of use, a duration of time, a measurement of distance traveled for the asset, or a failure rate. The method can further include utilizing the indicator to perform a repair on two or more assets.

The inventive subject matter described herein can be embodied in the form of computer-implemented processes and apparatus for practicing those processes. The inventive subject matter described herein also can be embodied in the form of computer program code including computer-readable instructions embodied in tangible media, such as floppy diskettes, CD-ROMs, hard drives, flash memories or any other computer-readable storage medium, wherein, when the computer program code is loaded into and executed by a computer, the computer becomes an apparatus for practicing the inventive subject matter. When implemented on a computer, the computer program code configures the computer to create specific logic circuits or processing modules. It is contemplated that use of tangible media may not be necessary in each instance since, in some applications, the computer program code may be downloaded for a remote site, e.g., a remote serve, via a communications network to be directly loaded into the computer.

While several embodiments of the inventive subject matter have been shown and described herein, these embodiments are provided by way of example only. Numerous variations, changes and substitutions may occur without departing from the patentable scope of the inventive subject matter described herein. Accordingly, it is intended that the inventive subject matter be limited only by the spirit and scope of the appended claims.

In embodiments, one or more of the methods set forth herein are carried out (at least partially automatically) with one or more components, that is, by hardware, software, or a combination thereof configured for execution of the method. For example, in one embodiment, a method comprises evaluating, with at least one component, a portion of sensor data related to an asset. The method further comprises evaluating, with the at least one component, a portion of historic data associated with at least one historic repair to the asset. The method further comprises indicating, with the at least one component, a future repair to perform on the asset based on at least one of the portion of sensor data or the portion of historic data. (“With at least one component” means all the steps may be carried out by one component, that each step may be carried out by a different component, or that some steps are carried out by one component and other steps are carried out by one or more other, different components.)

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur this distinction is captured by the terms “may” and “may be.”

This written description uses examples to disclose the inventive subject matter and also to enable those of ordinary skill in the art to practice the inventive subject matter, including making and using a devices or systems and performing incorporated methods. The patentable scope of the inventive subject matter is defined by the claims, and may include other examples. Such other examples are intended to be within the scope of the claims if they have structural elements that do not differentiate from the literal language of the claims, or if they include equivalent structural elements with insubstantial differences from the literal language of the claims.

What is claimed is:

1. A method comprising:
evaluating, with at least one component, a portion of sensor data related to an asset;
adjusting, with the at least one component, a repair indicator of a future repair of the asset based on the portion of the sensor data;
evaluating, with the at least one component, a portion of historic data associated with at least one of at least one historic repair to the asset or operation of a group of corresponding assets; and
indicating, with the at least one component, a repair to perform on the asset based on the portion of sensor data, the repair indicator that is adjusted, and the portion of historic data.

2. The method of claim 1, wherein:
evaluating the portion of sensor data comprises collecting data indicative of an incipient malfunction in the asset and processing the data indicative of incipient malfunctions to generate a prediction of a failure in the asset and at least one repair likely to prevent the failure of the asset;
the portion of historic data is associated with the operation of the group of corresponding assets, and evaluating the portion of historic data comprises processing usage data indicative of usage of the asset relative to the portion of historic data to generate a usage profile for the asset; and
adjusting the repair indicator comprises determining a repair weight indicative of a probability that the at least one repair will prevent the predicted failure and adjusting the repair weight based on the usage profile of the asset.

3. The method of claim 1, wherein:
adjusting the repair indicator comprises adjusting a manufacturer suggested indicator to perform the future repair of the asset based on the portion of the sensor data;
the portion of historic data is associated with the at least one historic repair to the asset; and
the repair to perform on the asset is indicated based on the portion of sensor data, the adjusted manufacturer suggested indicator, and the portion of historic data.

4. The method of claim 1, further comprising generating an estimated cost for the future repair based on at least one of the portion of sensor data or the portion of historic data.

5. The method of claim 1, further comprising collecting conditions of use data related to the asset, wherein the conditions of use data is associated with at least one of a location of the asset, a weather condition for a location of the asset, a cargo load related to the asset, or a duration of time the asset is used;
wherein the future repair is indicated based on the portion of sensor data, the portion of historic data, and the conditions of use data; and
wherein the portion of sensor data is from at least one of a wheel input, a load detector, a hot bearing detector, a dragging equipment, a real time sensor, a wheel degrade sensor, a flat spot detector, or an equipment health data sensor associated with the asset.

6. The method of claim 1, further comprising receiving the portion of sensor data for the asset from at least one of a wheel input, a load detector, a hot bearing detector, a dragging equipment, a real time sensor, a wheel degrade sensor, a flat spot detector, or an equipment health data sensor.

7. The method of claim 1, further comprising collecting first conditions of use data related to the asset, wherein first conditions of use data is utilized to facilitate indicating the future repair.

8. The method of claim 7, wherein the first conditions of use data is associated with at least one of a location of the asset, a weather condition for a location of the asset, a cargo load related to the asset, or a duration of time the asset is used.

9. The method of claim 8, further comprising:
scheduling an additional repair for an additional asset based on at least one of the portion of sensor data or the portion of historic data; and
scheduling the additional repair a second conditions of use data.

10. The method of claim 9, wherein second conditions of use data related to the additional asset is substantially similar to the first conditions of use data of the asset.

11. The method of claim 1, further comprising communicating information including at least one of an asset identification, the future repair, an estimated time of the future repair, a part associated with the future repair, or a cost of the future repair.

12. The method of claim 1, further comprising further adjusting the manufacturer suggested indicator to perform the future repair based on the portion of historic data.

13. The method of claim 1, further comprising generating an indicator to perform the future repair on the asset, wherein the indicator relates to at least one of the asset or a part associated with the future repair.

14. The method of claim 13, wherein the indicator is at least one of a duration of use, a duration of time, a measurement of distance traveled for the asset, or a failure rate.

15. The method of claim 14, further comprising utilizing the indicator to perform the future repair on two or more assets.

16. A system comprising:
a first component configured to collect a portion of sensor data related to an asset and a portion of historic data related to a historic repair performed on the asset; and
a second component configured to identify an indicator to perform a future repair on two or more assets based on the portion of sensor data collected by the first component and the portion of historic data collected by the first component,
wherein the second component is configured to dynamically adjust a manufacturer suggested indicator to perform the future repair based on the portion of sensor data, wherein the manufacturer suggested indicator is defined by a manufacturer of one of the two or more assets.

17. The system of claim 16, further comprising a third component configured to schedule the future repair for one of the two or more assets.

18. The system of claim 16, wherein the indicator relates to the one of the two or more assets or a part used for the future repair and the indicator is at least one of a duration of use, a duration of time, a measurement of distance traveled for one of the two or more assets, or a failure rate.

19. The system of claim 16, wherein the second component is configured to further dynamically adjust the manufacturer suggested indicator to perform the future repair based on the portion of the historic data.

20. A system comprising:
one or more processors configured to evaluate a portion of sensor data related to an asset, adjust a manufacturer suggested indicator to perform a future repair of the asset based on the portion of sensor data, evaluate a portion of historic data associated with a repair to the asset, and determine a repair to perform on the asset based on the portion of sensor data, the manufacturer suggested indicator, and the portion of historic data.
